(19) United States
(12) Patent Application Publication
(10) Pub. No.: US 2013/0133483 A1
(43) Pub. Date: May 30, 2013

(54) Synthesis of Nanoparticles Using Reducing Gases

(71) Applicants: Hong Yang, Champaign, IL (US); Jianbo Wu, Poughkeepsie, NY (US); Miao Shi, Rochester, NY (US); Adam Gross, Glencoe, IL (US)

(72) Inventors: Hong Yang, Champaign, IL (US); Jianbo Wu, Poughkeepsie, NY (US); Miao Shi, Rochester, NY (US); Adam Gross, Glencoe, IL (US)

(73) Assignee: UNIVERSITY OF ROCHESTER, Rochster, NY (US)

(21) Appl. No.: 13/583,467

(22) PCT Filed: Mar. 8, 2011
(86) PCT No.: PCT/US2011/027588

§ 371 Date: Dec. 17, 2012

Related U.S. Application Data
(60) Provisional application No. 61/311,414, filed on Mar. 8, 2010.
(60) Provisional application No. 61/356,764, filed on Jun. 21, 2010.
(60) Provisional application No. 61/388,159, filed on Sep. 30, 2010.

(51) Int. Cl. B22F 9/18

(52) U.S. Cl. CPC B22F 9/18; B82Y 40/00
USPC 75/351; 75/370; 75/363; 977/896

(57) ABSTRACT

Selective gas-reducing methods for making shape-defined metal-based nanoparticles. By avoiding the use of solid or liquid reducing reagents, the gas reducing reagent can be used to make shape well-defined metal- and metal alloy-based nanoparticles without producing contaminates in solution. Therefore, the post-synthesis process including surface treatment become simple or unnecessary. Weak capping reagents can be used for preventing nanoparticles from aggregation, which makes the further removing the capping reagents easier. The selective gas-reducing technique represents a new concept for shape control of nanoparticles, which is based on the concepts of tuning the reducing rate of the different facets. This technique can be used to produce morphology-controlled nanoparticles from nanometer- to submicron- to micron-sized scale. The Pt-based nanoparticles show improved catalytic properties (e.g., activity and durability).

### CROSS-REFERENCE TO RELATED APPLICATIONS

This application claims priority to U.S. provisional patent application No. 61/311,414, filed Mar. 8, 2010, and U.S. provisional patent application No. 61/356,764, filed Jun. 21, 2010, and U.S. provisional patent application No. 61/388,159, filed Sep. 30, 2010, the disclosures of which are incorporated herein by reference.

### STATEMENT REGARDING FEDERALLY SPONSORED RESEARCH

This invention was made with government support under contract no. DMR-0449849 awarded by the National Science Foundation. The government has certain rights in the invention.

### FIELD OF THE INVENTION

The present invention generally relates to nanoparticles and methods for making nanoparticles. More particularly, the present invention relates to methods of making metal and metal-alloy nanoparticles using reducing gases and nanoparticles made thereby.

### BACKGROUND OF THE INVENTION

Platinum and other noble metals possess important catalytic properties for a range of chemical reactions. Such catalytic properties relate to platinum's superior ability to absorb and dissociate hydrogen, carbon monoxide, sulfur, nitrogen oxides and various other molecules. For example, platinum has been used in automotive applications as an active component for catalyzing decomposition of various toxic exhaust gases. An important catalytic property of platinum is its ability to absorb and dissociate important chemical species, such as hydrogen and oxygen species. This catalytic property has allowed platinum and its alloys to be used as catalysts for important partial oxidation and reduction reactions in making pharmaceutical compounds and electrocatalysts in low-temperature fuel cells. Proton exchange membrane fuel cells (PEMFCs) using hydrogen as fuel have been important in the development of clean energy sources and direct methanol fuel cells (DMFCs) have been developed as power sources for portable microelectronic devices. PEMFCs are also being developed as potential power sources for microeletronic devices such as notebook computers.

One issue relating to the use of platinum catalysts is the high cost of platinum. Because of this high cost, it is critical that consumption of platinum be reduced without sacrificing catalytic performance in practical applications. The high activity is closely related to the shape of the catalysts. Those electrocatalysts used in PEMFCs and DMFCs have traditionally been made of carbon-black supported nanoparticles of platinum and platinum alloys, such as PtRh, PtCo, PtFe and PtNi. Commercially available electrocatalysts include porous carbon supported platinum nanoparticles sold under the name Vulcan XC-72R by E-TEK. Typical diameters of platinum nanoparticles used in such fuel cell catalysts are between 2 and 13 nanometers, and more commonly between 3 and 6 nanometers. Small particle size is necessary to achieve a catalyst having a large surface area.

Improving the sluggish kinetics of the electrocatalytic oxygen reduction reaction (ORR) is critical to advancing hydrogen fuel cell technology. An important threshold value in ORR catalyst activity is a four- to eight-fold improvement in activity per unit mass of platinum (Pt) over the current commercial carbon-supported Pt catalyst (Pt/C, ˜0.1 A/mg-Pt) that are used in the vehicle fuel cells to allow fuel-cell powertrains to become cost-competitive with their internal-combustion counterparts. While great advancements have been made in recent years, the Pt area-specific ORR activity of the best catalysts is still far below the value being demonstrated for Pt₃Ni (111) single crystal surface, which is 90 times that of Pt/C. A 9-fold enhancement in specific activity is achieved by changing the (100) to (111) Pt₃Ni crystal surface. This result is very intriguing, and an important clue for the development of next-generation ORR catalysts.

In the past several years, substantial research efforts have been placed on the shape and composition controls of Pt binary metal nanoparticles to meet the challenges in the preparation of highly active catalysts. Not only the composition and size, have to be tightly controlled but also the shape has to be tightly controlled in order to have the proper surface atomic arrangement and electronic property.

### BRIEF SUMMARY OF THE INVENTION

In an aspect the present invention provides a method of making metal or metal-alloy nanoparticles comprising the steps of: a) providing at least one reducible metal precursor (e.g. metal-based salts and hydrated forms thereof, metal-based acids and hydrated forms thereof, metal-based bases and hydrated forms thereof, organometallic compounds and the like) and, optionally, a solvent and/or a surfactant, wherein the solvent is selected from organic solvent, aqueous solvent, ionic liquid and combinations thereof; b) maintaining the material from a) at least at a reducing temperature at which the at least one reducible metal precursor is reduced; and c) contacting the material from b) with a reducing gas (e.g., carbon monoxide (CO), hydrogen (H₂), forming gas comprising nitrogen gas and hydrogen (H₂), syngas comprising hydrogen (H₂) and carbon monoxide (CO), ammonia gas (NH₃), ozone (O3), peroxide (H₂O₂), hydrogen sulfide (H₂S), ethylenediamine and combinations such gases) at the reducing temperature, thereby forming nanoparticles. The nanoparticles have, for example, a shape selected from octahedral, tetrahedral, dodecahedron, icosahedral, truncated octahedral, truncated tetrahedral, cubic, spherical, bipyramid, multipod, nanowire, and porous nanowire. The nanoparticles have, for example, an allowed convex or concave polyhedron structure. The method, optionally, further comprising the step of collecting the nanoparticles.

In an aspect, the present invention provides nanoparticles comprising a metal selected from gold, silver, palladium, platinum, or a metal alloy, wherein the nanoparticles have an icosahedron shape comprised of multiple tetrahedral nanocrystals with multiple twin planes, resulting in a structure bound by multiple {111} facets. The metal-alloy nanoparticles can have a convex or concave polyhedral structure.

In an embodiment, the present invention provides metal-alloy nanoparticles comprising platinum having a shape selected from a group of truncated octahedral, tetrahedral, icosohedral, cubic, multipod or nanowire having the formula PtₓMₐQ_{b}T_{c}, wherein x+a+b+c=100 and x is from 1 to 99, and wherein M or Q or T is a metal selected from the group consisting of palladium, rhodium, gold, silver, nickel, cobalt, copper, tungsten, iridium, titanium, vanadium, zirconium, niobium, molybdenum, manganese, indium, tin, antimony, lead, bismuth, and iron.

In an aspect, the present invention provides a catalyst material comprising nanoparticles produced by the methods disclosed herein. For example, the catalyst material can catalyze an oxygen reduction reaction (ORR), an oxygen evolution reaction (OER), formic acid oxidation reaction (FAOR), methanol oxidation reaction (MOR), ethanol oxidation reaction, oxygen evolution reaction and the like. For example, the catalyst material can be used in a fuel cell (e.g., hydrogen proton exchange membrane fuel cells (PEMFCs), direct formic acid fuel cells, direct methanol fuel cells (DMFCs), direct ethanol fuel cells and the like) or metal-air battery. For example, nanoparticles where the longest dimension of the nanoparticles is from 1 nm to 20 nm or 2 nm to 12 nm can be used in the catalyst materials.

### BRIEF DESCRIPTION OF THE FIGURES

FIG. 1a is a transmission electron micrograph of Pt cubes obtained in oleylamine/oleic acid at 230° C. for 30 minutes according to the present invention. FIG. 1b is a high-resolution transmission electron micrograph of Pt cubes obtained in oleylamine/oleic acid at 210° C. for 30 minutes according to the present invention.

FIG. 2a is a transmission electron micrograph of PtNi cubes obtained in oleylamine/oleic acid at 210° C. for 30 minutes according to the present invention. FIG. 2b is a high-resolution transmission electron micrograph of PtNi cubes obtained in oleylamine/oleic acid at 210° C. for 30 minutes according to the present invention.

FIG. 3 is a graph showing energy dispersive X-ray (EDX) spectra of PtNi cubes obtained in oleylamine/oleic acid at 210° C. for 30 minutes according to the present invention.

FIG. 4a is a transmission electron micrograph of Pt₃Ni truncated octahedra obtained in oleylamine/oleic acid at 210° C. for 30 minutes according to the present invention. FIG. 4b is a graph showing energy dispersive X-ray (EDX) spectra of Pt₃Ni octahedra obtained in oleylamine/oleic acid at 210° C. for 30 minutes according to the present invention.

FIG. 5a is a transmission electron micrograph of PtNi₃ truncated octahedra and tetrahedra obtained in oleylamine/oleic acid at 210° C. for 30 minutes according to the present invention. FIG. 5b is a graph showing energy dispersive X-ray (EDX) spectra of PtNi₃ truncated octahedra and tetrahedra obtained in oleylamine/oleic acid at 210° C. for 30 minutes according to the present invention.

FIG. 6a is a transmission electron micrograph of Pt₃Ni octahedra obtained in oleylamine/diphenyl ether at 210° C. for 30 minutes according to the present invention. FIG. 6b is a high-resolution transmission electron micrograph of Pt₃Ni octahedra obtained in oleylamine/diphenyl ether at 210° C. for 30 minutes according to the present invention.

FIG. 7a is a transmission electron micrograph of PtNi octahedra obtained in oleylamine/diphenyl ether at 210° C. for 30 minutes according to the present invention. FIG. 7b is a high-resolution transmission electron micrograph of PtNi octahedra obtained in oleylamine/diphenyl ether at 210° C. for 30 minutes according to the present invention.

FIG. 8a is a transmission electron micrograph of Pt₃Ni cubes obtained in DDA/AAA at 210° C. for 30 minutes according to the present invention. FIG. 8b is a transmission electron micrograph of Pt₃Ni cubes obtained in HDA/AAA at 210° C. for 30 minutes according to the present invention. FIG. 8c is a transmission electron micrograph of Pt₃Ni cubes obtained in ODA/AAA at 210° C. for 30 minutes according to the present invention.

FIG. 9a is a transmission electron micrograph of Pt₃Fe cubes obtained in oleylamine/oleic acid at 210° C. for 30 minutes according to the present invention. FIG. 9b is a high-resolution transmission electron micrograph of Pt₃Fe cubes obtained in oleylamine/oleic acid at 210° C. for 30 minutes according to the present invention.

FIG. 10a is a transmission electron micrograph of PtFe cubes obtained in oleylamine/oleic acid at 210° C. for 30 minutes according to the present invention. FIG. 10b is a transmission electron micrograph of PtFe₃ concave cubes obtained in oleylamine/oleic acid at 210° C. for 30 minutes according to the present invention.

FIG. 11a is a transmission electron micrograph of Pt₃Co cubes obtained in oleylamine/oleic acid at 230° C. for 30 minutes addition according to the present invention.

FIG. 11b is a high-resolution transmission electron micrograph of Pt₃Co cubes obtained in oleylamine/oleic acid at 230° C. for 30 minutes according to the present invention.

FIG. 12a is a transmission electron micrograph of Pt₃Co octahedra obtained in oleylamine/diphenyl ether at 210° C. for 30 minutes according to the present invention. FIG. 12b is a high-resolution transmission electron micrograph of Pt₃Co octahedra obtained in oleylamine/diphenyl ether at 210° C. for 30 minutes according to the present invention.

FIG. 13 is a transmission electron micrograph of Pt₃Cu truncated octahedra obtained in oleylamine/oleic acid at 230° C. for 30 minutes according to the present invention.

FIG. 14a is a transmission electron micrograph of PtPd cubes obtained in oleylamine/oleic acid at 230° C. for 30 minutes according to the present invention. FIG. 14b is a high-resolution transmission electron micrograph of PtPd cubes obtained in oleylamine/oleic acid at 230° C. for 30 minutes according to the present invention.

FIG. 15 is a transmission electron micrograph of PtAu truncated tetrahedra obtained in oleylamine/oleic acid at 180° C. for 30 minutes according to the present invention.

FIG. 16 is a transmission electron micrograph of PtAg octahedra obtained in oleylamine/oleic acid at 180° C. for 30 minutes according to the present invention.

FIG. 17a is a transmission electron micrograph of Pt₃Ni icosahedra obtained in oleylamine/oleic acid at 210° C. for 30 minutes according to the present invention. FIG. 17b is a high-resolution transmission electron micrograph of Pt₃Ni icosahedra obtained in oleylamine/oleic acid at 210° C. for 30 minutes according to the present invention.

FIG. 18a is a transmission electron micrograph of Pt₃Pd icosahedra obtained in oleylamine/DPE at 210° C. for 30 minutes according to the present invention. FIG. 18b is a high-resolution transmission electron micrograph of Pt₃Pd icosahedra obtained in oleylamine/DPE at 210° C. for 30 minutes according to the present invention.

FIG. 19a is a transmission electron micrograph of Pt₃Au icosahedra obtained in oleylamine/oleic acid at 210° C. for 30 minutes according to the present invention. FIG. 19b is a high-resolution transmission electron micrograph of Pt₃Au icosahedra obtained in oleylamine/oleic acid at 210° C. for 30 minutes according to the present invention.

FIG. 20 is a transmission electron micrograph of Pd octahedra obtained in EG/PVP at 160° C. for 30 minutes addition according to the present invention.

FIG. 21 is a transmission electron micrograph of Au truncated tetrahedra obtained in aqueous solution at 90° C. for 30 minutes according to the present invention.

FIG. 22a is a transmission electron micrograph of truncated octahedral PtFe@PtPd nanoparticles obtained in oleylamine/oleic acid at 210° C. for 30 minutes according to the present invention. FIG. 22b is a high-resolution transmission electron micrograph of truncated octahedral PtFe@PtPd nanoparticles obtained in oleylamine/oleic acid at 210° C. for 30 minutes according to the present invention. FIG. 22c is a scan transmission electron micrograph of truncated octahedral PtFe@PtPd nanoparticles obtained in oleylamine/oleic acid at 210° C. for 30 minutes according to the present invention. FIG. 22d is an energy dispersive X-ray (EDX) spectra linear profile of truncated octahedral PtFe@PtPd nanoparticles obtained in oleylamine/oleic acid at 210° C. for 30 minutes according to the present invention.

FIG. 23 is an energy dispersive X-ray (EDX) spectrum of truncated octahedral PtFe@PtPd nanoparticles obtained in oleylamine/oleic acid at 210° C. for 30 minutes according to the present invention.

FIG. 24a is a transmission electron micrograph of truncated cubic Ag@PtNi nanoparticles obtained in oleylamine/oleic acid at 210° C. for 30 minutes according to the present invention. FIG. 24b is a high-resolution transmission electron micrograph of cubic Ag@PtNi nanoparticles obtained in oleylamine/oleic acid at 210° C. for 30 minutes according to the present invention. FIG. 24c is a scan transmission electron micrograph of cubic Ag@PtNi nanoparticles obtained in oleylamine/oleic acid at 210° C. for 30 minutes according to the present invention. FIG. 24d is a power X-ray diffraction (PXRD) patterns of cubic Ag@PtNi nanoparticles obtained in oleylamine/oleic acid at 210° C. for 30 minutes according to the present invention.

FIG. 25a is a transmission electron micrograph of AuAg nanowires obtained in oleylamine/oleic acid at 210° C. for 30 minutes according to the present invention. FIG. 25b is a high-resolution transmission electron micrograph of AuAg nanowires obtained in oleylamine/oleic acid at 210° C. for 30 minutes according to the present invention.

FIG. 26 is a transmission electron micrograph of Pt3Pd cubes in oleylamine/oleic acid by 5% H₂ at 210° C. for 30 minutes according to the present invention.

FIG. 27 is a transmission electron micrograph of Pt octopods in oleylamine/oleic acid by 5% H₂ at 210° C. for 30 minutes according to the present invention.

FIG. 28 is a transmission electron micrograph of concave cubic Pt nanoparticles.

FIG. 29 is a transmission electron micrograph of concave cubic Pt nanoparticles.

FIG. 30 is a transmission electron micrograph of concave cubic Pt nanoparticles.

FIG. 31a is a cyclic voltammetry (CV) curve of Pt₃Ni cubic, octahedral, and icosahedral nanoparticles obtained in oleylamine/oleic acid at 210° C. for 30 minutes according to the present invention, and the commercial Pt catalyst in the HClO₄ solutions. FIG. 31b is an ORR polarization curves of Pt₃Ni cubic, octahedral, and icosahedral nanoparticles obtained in oleylamine/oleic acid at 210° C. for 30 minutes according to the present invention, and the commercial Pt catalyst in the HClO₄ solutions. FIG. 31c is plots of the ORR area-specific activities between 0.84 and 0.94 V of Pt₃Ni cubic, octahedral, and icosahedral nanoparticles obtained in oleylamine/oleic acid at 210° C. for 30 minutes according to the present invention, and the commercial Pt catalyst in the HClO₄ solutions. FIG. 31d is the area-specific activities at 0.9 V of Pt₃Ni cubic, octahedral, and icosahedral nanoparticles obtained in oleylamine/oleic acid at 210° C. for 30 minutes according to the present invention, and the commercial Pt catalyst in the HClO₄ solutions.

FIG. 32a is plots of the ORR mass-specific activities between 0.84 and 0.94 V of Pt₃Ni cubic, octahedral, and icosahedral nanoparticles obtained in oleylamine/oleic acid at 210° C. for 30 minutes according to the present invention, and the commercial Pt catalyst in the HClO₄ solutions. FIG. 32b is the mass-specific activities at 0.9 V of Pt₃Ni cubic, octahedral, and icosahedral nanoparticles obtained in oleylamine/oleic acid at 210° C. for 30 minutes according to the present invention, and the commercial Pt catalyst in the HClO₄ solutions.

FIGS. 33a-d are TEM images of Pt₃Ni nanocrystals with truncated octahedron population of a) 70%, b) 90%, and c) 100%; and d) HR-TEM image of a truncated octahedron showing the (111) lattice.

FIG. 34 a) STEM image and its corresponding b) Pt (M line) and c) Ni (K line) elemental maps, and d) EDX spectrum of t,o-Pt₃Ni nanoparticles; and e) PXRD patterns of the three Pt₃Ni samples.

FIGS. 35a-f show the TEM images of the Pt nanoparticles obtained at 160° C. for reaction time ranging from 30 to 160 minutes. FIG. 33a is a transmission electron micrograph of Pt mutlipods obtained at 160° C. for 30 minutes according to this invention. FIG. 32b is a transmission electron micrograph of Pt mutlipods obtained at 160° C. for 60 minutes according to this invention. FIG. 1c is a transmission electron micrograph of Pt mutlipods obtained at 160° C. for 90 minutes according to this invention. FIG. 1d is a transmission electron micrograph of Pt mutlipods obtained at 160° C. for 160 minutes according to this invention. FIG. 1e is a transmission electron micrograph of Pt mutlipods obtained at 160° C. for 220 minutes after first addition according to this invention. FIG. 1f is a transmission electron micrograph of Pt mutlipods obtained at 160° C. for 280 minutes after second addition according to this invention. FIGS. 1g and 1h are high-resolution transmission electron micrographs of Pt mutlipods under two different growth directions obtained according to this invention.

FIG. 36a is a graph showing schematic illustration of ligand exchanging hexadecylamine-capped Pt multipods with n-butylamine according to this invention. FIG. 36b is a transmission electron micrograph of hexadecylamine-capped Pt multipods before ligand exchange with n-butylamine according to this invention. FIG. 36c is a transmission electron micrograph of hexadecylamine-capped Pt multipods after ligand exchange with n-butylamine according to this invention. FIG. 36d is a graph showing thermogravimetric analysis traces of hexadecylamine-capped Pt multipods before and after ligand exchange with n-butylamine according to this invention.

FIG. 37 is a graph showing cyclic voltammetry curves of supportless hexadecylamine-capped Pt multipods before and after ligand exchange with n-butylamine according to this invention.

FIG. 38a is a graph showing polarization curves of ligand exchange treated supportless-Pt multipods network before and after 10,000 CV cycles according to this invention. FIG. 38b is a graph showing polarization curves of E-TEK catalysts before and after 10,000 CV cycles according to this invention. FIG. 38c is a graph showing CV curves of ligand exchange treated supportless-Pt multipods network before and after 10,000 CV cycles according to this invention. FIG. 4d is a graph showing CV curves of E-TEK catalysts before and after 10,000 CV cycles according to this invention. FIG. 38e is a graph showing the evolution of electrochemical surface areas of ligand exchange treated supportless-Pt multipods network and E-TEK catalysts during 10,000 CV cycles according to this invention.

### DETAILED DESCRIPTION OF THE INVENTION

The present invention provides methods of making nanoparticles (also referred to as nanocrystals), nanoparticles made by the methods, and nanoparticles having specific shapes. Also provides ligand exchange methods for associating small molecules with the surface of nanoparticles.

In an aspect, the present invention provides methods for making nanoparticles and nanoparticles made by the methods. The nanoparticles can be, for example, metal, metal-alloy or core-shell metal/metal-alloy nanoparticles comprising a wide-variety of metals. For example, the nanoparticles can be made with controlled size, shape and composition In an embodiment, the present method provides a method of making metal or metal-alloy nanoparticles comprising the steps of: a) providing at least one reducible metal precursor and, optionally, a solvent, and/or a surfactant; b) maintaing the material from step a) at least at reducing temperature at which the at least one first reducible metal precursor is reduced; and c) contacting the material with a reducing gas at least at the reducing temperature, thereby forming nanoparticles. In an embodiment, the method also includes a step of collecting the nanoparticles.

In an embodiment, the present invention provides a method of making core-shell metal or metal-alloy nanoparticles, where the core and shell can independently comprise a metal or metal-alloy. The method comprises the steps of: a) providing at least one reducible metal or metal-alloy core precursor(s) and, optionally, a solvent, and/or a surfactant; b) maintaining the material from step a) at least at a first reducing temperature at which the at least one reducible metal core precursor is reduced; and c) contacting the material from b) with a reducing gas at at least the reducing temperature, thereby forming metal or metal-alloy nanoparticles, where the nanoparticles can have a shape selected from octahedral, tetrahedral, dodecahedron, icosahedral, truncated octahedral, truncated tetrahedral, cubic, spherical, bipyramid, multipod, nanowire, and porous nanowire; d) combining the nanoparticles from step c) with at least one reducible metal shell precursor and, optionally, a solvent, and/or a surfactant; e) maintaining the material from d) at least at a second reducing temperature at which the at least one reducible metal shell precursor is reduced; and f) contacting the material from e) with a reducing gas at at least the second reducing temperature, thereby forming core-shell nanoparticles, wherein the shell is a metal or metal alloy. In an embodiment, the method also includes a step of collecting the nanoparticles. The core-shell nanoparticles can have a shape selected from octahedral, tetrahedral, dodecahedron, icosahedral, truncated octahedral, truncated tetrahedral, cubic, spherical, bipyramid, multipod, nanowire, and porous nanowire. The core-shell nanoparticles can have an allowed convex or concave polyhedron structure. The core-shell nanoparticles can have, for example, an average longest dimension of from 1 nanometer to 100 nanometers, including all ranges and values to the nanometer therebetween.

It is desirable to exchange at least a portion of surfactant, if any, which is attached to the surface of the nanoparticle with small molecules. Without intending to be bound by any particular theory, it is considered that such nanoparticles exhibit increased catalytic activity.

In an embodiment, the methods also comprise the step of contacting the nanoparticles to small molecules. In an embodiment, the nanoparticles are loaded onto a support material (e.g., carbon, TiO₂, TiC, TiW, SiC, SiBCN, SiBN, BN, WC, metal meshes, SiO₂, Al₂O₃, zeolite, mesoporous materials, other porous supports and the like) before contacting the nanoparticles with small molecules. The term “small molecules” as used herein means compounds containing one or more functional groups, which have at least one nitrogen atom, oxygen atom, sulfur atom, or phosphorus atom. The functional group(s) can be, for example, alcohols, amines, carboxylic acids, phosphonic acid esters, phosphate esters, and the like. The small molecules can also have combinations of functional groups. It is desirable that the small molecules be labile (i.e., the small molecules readily disassociate from the surface of the nanoparticle). In an embodiment, the small molecules comprise at least one alkyl moiety and all of the alkyl moieties of small molecules have from 1 carbon to 6 carbons, including all individual numbers of carbons there between. In an embodiment, the small molecule is a primary amine selected from n-butylamine, sec-butylamine, tert-butylamine, isobutylamine, propylamine, ethylamine, methylamine and combinations thereof. In an embodiment, the small molecules do not comprise carbon. In an embodiment, the small molecule has 20 or fewer atoms.

After contacting the nanoparticles with the small molecules, the small molecules are attached to at least a portion of the surface of the nanoparticle. By “attached” it is meant that the small molecules are located on the surface of the nanoparticle due to interaction of the small molecule with the nanoparticle. The interaction can be, for example, as a result of van der Waals forces, ionic interactions or covalent bond formation. In various embodiments, the small molecules are attached to at least 1 to 100% of the surface of the nanoparticles, including all ranges and integer percentages therebetween. The portion of surface of the nanoparticle to which the small molecules can be attached can be determined by, for example, infrared (IR) spectroscopy, Raman spectroscopy, nuclear magnetic resonance (NMR) spectroscopy and X-ray photoelectron Spectroscopy (XPS), and the like.

The nanoparticles can be contacted with small molecules by any manner which results in the attachment of the small molecules to at least a portion of the surface of the nanoparticles. For example, nanoparticles can be mixed with small molecules in solution. The mixing can be done using, for example, stirring, vortexing, or sonication. Typically, an excess of small molecules are added. The nanoparticles and small molecules can be mixed at room temperature (e.g., ambient temperature). In various embodiments, the nanoparticles and small molecules can be mixed at temperatures from 18° C. to 100° C., including all ranges and values to the degree Celsius therebetween.

In an aspect of the present invention, any nanoparticles can be contacted with small molecules as described herein. For example, any nanoparticles which have surfactant attached at least a portion of their surface can be contacted with small molecules, which results in the small molecules being attached to at least a portion of surface of the nanoparticles.

The reducible metal precursor (also referred to as reducible metal core precursor or reducible metal shell precursor) is a material which on contact with a reducing gas at a particular temperature is reduced. For example, the reducible metal precursor comprises a metal selected from platinum, palladium, gold, silver, ruthenium, rhodium, osmium, iridium, titanium, vanadium, chromium, manganese, molybdenum, zirconium, niobium, tantalum, zinc, cadmium, bismuth, gallium, germanium, indium, tin, antimony, lead, tungsten, samarium, gadolinium, copper, cobalt, nickel, iron and combinations thereof. The reducible metal precursor is, for example, a metal-based salt or a hydrated form thereof, a metal-based acid or a hydrated form thereof, a metal-based base or hydrated form thereof, or an organometallic compound.

Examples of metal-based salts include, but are not limited to, PtCl₂, PtCl₄, K₂PtCl₆, K₂PtCl₄, H₂PtCl₆, H₂PtBr₆, Pt(NH₃)Cl₂, PtO₂, Na₂PdCl₄, Pd(NO₃)₂, HAuCl₄, Ag(NO₃)₂, NiCl₂, CoCl₂, CuCl₂, FeCl₃, and the like. Examples of metal-based salts also include hydrated forms of such metal-based salts.

Examples of organometallic compounds include, but are not limited to, metal-acetylacetonate compounds (such as Pt(acac)₂, Pd(acac)₂, Ni(acac)₂, Co(acac)₂, Cu(acac)₂, Fe(acac)₃, Ag(acac), and the like), metal-fluoroacetylacetonate compounds (such as Pt(CF₃COCHCOCF₃)₂, Ag(CF₃COCHCOCF₃) and the like), a metal-acetate compounds (such as Pd(ac)₂, Ni(ac)₂, Co(ac)₂, Cu(ac)₂, Fe(ac)₃, silver stearate, and the like), metal-cyclooctadience compounds (such as Pt(1,5-C₈H₁₂)Cl₂, Pt(1,5-C₈H₁₂)Br₂, Pt(1,5-C₈H₁₂)I₂, and the like), and the like.

Surfactants can, optionally, be used in the method. The surfactant can have one or more functional groups comprising at least one nitrogen, oxygen, sulfur, phosphorus atom or a combination thereof. Examples of suitable surfactants include, but are not limited to, oleylamine, octadecylamine, hexadecylamine, dodecylamine, oleic acid, adamantaneacetic acid and adamantinecarboxylic acid, polyvinylpyrrolidone (PVP), citrate acid, sodium citrate, cetylpyridinium chloride (CPC), tetractylammonium bromide (TTAB), cetyl trimethylammonium bromide (CTAB), cetyl trimethylammonium chloride (CTACl) and combinations of surfactants.

Solvents can, optionally, be used in the method. The solvent can be an organic solvent, an aqueous solvent (comprising from 0.1% to 100% water, including all ranges and values to 0.1% therebetween), an ionic liquid, or a mixture thereof. Examples of suitable organic solvents include, but are not limited to alcohols (such as of methanol, ethanol, ethylene glycol (EG), glycerol, polyethylene glycol (PEG), and the like), ethers (such as diphenyl ether, octyl ether and the like) and amines (such as oleylamine, octadecylamine, hexadecylamine, dodecylamine, and the like) and combinations of suitable organic solvents.

Ionic liquids are materials that may have a melting point at or below 150° C. Generally, ionic liquids are comprised of large, organic cations (e.g., quaternary ammonium cations, heterocyclic aromatic cations, imidazolium cations, pyrrolidinium cations, and the like) and anions (e.g., halogen ions, sulfate ions, nitrate ions, hexafluorophosphate ions, tetrafluoroborate ions, bis(triflylmethyl-sulfonyl) imide ions, and the like). Examples of ionic liquids suitable for use in the present method include, but are not limited to, 1-butyl-3-methylimidazolium bis(trifluoromethylsulfonyl)imide, 1-n-butyl-3-methylimidazolium hexafluorophosphate, 1,1,3,3-tetramethylguanidinium lactate, N-butylpyridinium tetrafluoroborate, 1-butyl-3-methylimidazolium tetrafluoroborate, 1-ethyl-3-methylimidazolium bis(trifluoromethyl sulfonyl)imide, thiol-functionalized ionic liquids and the like.

For example, the solvent is mixture of organic solvent and water and the organic solvent is ethylene glycol (EG) ethanol, methanol, polyethylene glycol (PEG) or a combination thereof.

The reaction materials (e.g., reducible precursor(s) and/or solvent(s) and/or surfactants(s) are contacted with reducing gas a temperature at which the reducible metal precursor can be reduced by the reducing gas. For example, the temperature can be from 5° C. to 380° C., including all ranges and all values to the degree Celsius therebetween. If the reducing temperature is greater than the ambient temperature (e.g., 30° C. to 380° C. and all ranges and all values to the degree Celsius therebetween), the reaction materials can be heated to at least the reaction temperature and the heated reaction materials contacted with reducing gas. As another example, reactions using water or aqueous solvents can be carried out at about room temperature. As yet another example, reactions using organic solvents can be carried out at 160° C. to 280° C., including all ranges and values to the degree Celsius therebetween.

The reducing gas reduces the reducible metal precursor(s) to form metal or metal-alloy nanoparticles. Without intending to be bound by any particular theory, it is considered that the reducing gas can preferentially interact with specific faces of the nanocrystal during growth of the nanocrystals resulting in specific nanoparticle shapes. In various embodiments, the reducing gas is selected from carbon monoxide (CO), hydrogen (H₂), forming gas comprising nitrogen gas and hydrogen (H₂) (present at from 1% to 100%, including all integers and ranges therebetween), syngas comprising hydrogen (H₂) and carbon monoxide (CO), ammonia gas (NH₃), ozone (O₃), peroxide (H₂O₂), hydrogen sulfide (H₂S), ethylenediamine and the like. In an embodiment, the reducing gas is produced in situ resulting from decomposition (e.g., thermal decomposition and photo decomposition) of a metal carbonyl compound such as, iron carbonyl compounds, cobalt carbonyl compounds, tungsten carbonyl compounds, molybdenum carbonyl compounds, nickel carbonyl compounds, osmium carbonyl compounds, vanadium carbonyl compounds, titanium carbonyl compounds, ruthenium carbonyl compounds, rhodium carbonyl compounds, and the like.

The reducible metal precursor can be contacted with reducing gas in a variety of ways as would be recognized by one having skill in the art. The reducible metal precursor can be contacted with a static or dynamic (e.g., a flow) atmosphere of the reducing gas. For example, a flow of reducing gas can be introduced into a container (e.g., a flask) holding a solution comprising the reducible metal precursor. As another example, the reaction mixture is contacted with reducing gas at a flow rate of 10 cm³/min to 210 cm³/min, including all ranges and values to the cm³/min therebetween. As yet another example, the reducing gas can be from metal carbonyl compounds sparged into a solution comprising the reducible metal precursor.

In an aspect, the present invention provides nanoparticles made by the methods of the present invention. For example, the nanoparticles are metal or metal-alloy nanoparticles having a shape selected from octahedral, tetrahedral, dodecahedron, icosahedral, truncated octahedral, truncated tetrahedral, cubic, spherical, bipyramid, multipod, nanowire, and porous nanowire. For example, the nanoparticles can have an allowed convex or concave polyhedron structure. The nanoparticles can have an average longest dimension of from 1 nanometer to 100 nanometers, including all ranges and values to the nanometer therebetween.

In an embodiment, the nanoparticles have an icosahedron shape comprised of multiple tetrahedral nanocrystals with multiple twin planes, resulting in a structure bound by multiple {111} facets.

In another embodiment, the nanoparticles are metal-alloy nanoparticles having the formula PtₓMₐQ_{b}T_{c}, where x+a+b+c=100 and x is from 1 to 99, including all ranges and inter values therebetween. M or Q or T are independently a metal selected from the group consisting of palladium, rhodium, gold, silver, nickel, cobalt, copper, tungsten, iridium, titanium, vanadium, zirconium, niobium, molybdenum, manganese, indium, tin, antimony, lead, bismuth, and iron. The nanoparticles have a shape selected from truncated octahedral, tetrahedral, icosohedral, cubic, multipod and nanowire.

In an aspect, the present invention provides metal, metal-alloy and core-shell nanoparticles. For example, the nanoparticles comprises a metal selected from gold, silver, palladium, platinum, or a platinum alloy. The nanoparticles can have an icosahedron shape comprised of multiple tetrahedral nanocrystals with multiple twin planes, resulting in a structure bound by multiple {111} facets.

For example, the nanoparticles are metal-alloy nanoparticles comprising platinum and have a shape selected from truncated octahedral, tetrahedral, icosohedral, cubic, multipod or nanowire. The platinum alloy has the formula PtₓMₐQ_{b}T_{c}, where x+a+b+c=100 and x is from 1 to 99, including all ranges and integers therebetween. M or Q or T are metals independently selected from palladium, rhodium, gold, silver, nickel, cobalt, copper, tungsten, iridium, titanium, vanadium, zirconium, niobium, molybdenum, manganese, indium, tin, antimony, lead, bismuth, and iron. The longest dimension of the nanoparticles is from 1 nanometer to 100 nanometers, including all integers and values to the nanometer therebetween. The metal-alloy nanoparticles of can have a convex or concave polyhedral structure.

In an embodiment, the nanoparticles comprise a platinum alloy having the formula PtₓMₐQ_{b}T_{c}, wherein x+a+b+c=100 and x is from 1 to 99, including all ranges and integers therebetween. M or Q or T are metals independently selected from palladium, rhodium, gold, silver, nickel, cobalt, copper, tungsten, iridium, titanium, vanadium, zirconium, niobium, molybdenum, manganese, indium, tin, antimony, lead, bismuth, and iron. The longest dimension of the nanoparticles is from 1 nanometer to 100 nanometers, including all ranges and values to the nanometer therebetween.

In an aspect the present invention also provides uses of the nanoparticles of the present invention. In an embodiment, the present invention provides a catalyst material comprising nanoparticles of the present invention. In an example, the longest dimension of the nanoparticles is from 1 nm to 20 nm, including all ranges and values to the nanometer therebetween. In another example, the longest dimension of the nanoparticles is from 2 nm to 12 nm, including all ranges and values to the nanometer therebetween. In various embodiments, the catalyst material catalyzes an oxygen reduction reaction (ORR), an oxygen evolution reaction (OER), formic acid oxidation reaction (FAOR), methanol oxidation reaction (MOR), ethanol oxidation reaction, or oxygen evolution reaction.

The catalyst materials can be used in devices such as, for example, fuel cells (such as hydrogen proton exchange membrane fuel cells (PEMFCs), direct formic acid fuel cells, direct methanol fuel cells (DMFCs) or direct ethanol fuel cells), metal-air batteries and the like. The catalyst materials can also be used in low-temperature fuel cells.

The shape-defined nanoparticles synthesized using reducing gases as described herein provide a general approach to make the well-shape-defined noble-metal-based nanoparticles. The method does not use solid or liquid reducing reagents, and while not intending to be bound by any particular theory, it is considered that using the reducing gas as a reducing reagent result in well-shape-defined noble-metal-based nanoparticles without any contaminates produced. Therefore, further treatment processes may become unnecessary or be simplified, which make industrial application of these methods desirable. When a reducing gas is used, it is considered that reduction reactions only occur when the reducing gas is adsorbed on the surface of the metal. Therefore, it is considered that use of reducing gases has the effect of selective reducing rate on different faces of the nanoparticles during formation of the nanoparticles, which makes it possible to control the shape, even with a weak capping agent, because most of reducing gas such as CO, H₂, NH₃, have preferential adsorption on the specific facet of metals (e.g., noble metals). Therefore, weak capping reagents can be used for avoiding aggregation of nanoparticles, which makes the removing the capping reagents (e.g., surface treatments) easier. It is considered that the new selective gas-reducing techniques described herein provide a new concept for shape-control methods of nanoparticle synthesis, based on, for example, tuning the reducing rate of the different facets, as opposed to conventional methods which use capping reagents to tune the rate of crystal growth by tuning surface energies of the different facets. It is also considered the new selective gas-reducing techniques provided herein can be used in morphology-control synthesis of nanoparticles from nanometer to sub-micron to micron scales. The well-designed shape of Pt-based alloy nanoparticles with the most catalytic active face exposed is believed to show great enhancement in the catalytic activity.

The ligand exchange method, as an effective surface treatment, is described herein to remove the surfactants from the surface of nanoparticles and maintain the property-active morphologies and dispersal of nanoparticles. Hyper-branched and truncated octahedral Pt-based nanoparticles are believed to show the show greater improvements in catalytic properties including the activity and durability because most of the active surfaces are exposed stably by gas-reducing.

In various exemplary embodiments, synthetic techniques for shape-defined catalytic nanoparticles, such as cubes, tetrahedra, truncated octahedral, icosahedral, rod, porous wire and multipod with the size of a few to tens of nanometers are provided. Such catalytic cubes and octahedra may be used as, for example, fuel cell catalysts.

In various exemplary embodiments, various cubic and octahedral metals and metal alloys according to the present invention may be synthesized without any solid or liquid reducing reagents, most of which will release some contaminants into the reaction solutions. Therefore, the some further post-synthesis process become unnecessary. Also, in various exemplary embodiments, carbon monoxide is used as the general reducing reagent in the synthesis of shape-defined noble metal-based alloys according to the present invention instead of employing typical reducing reagents (e.g., TBAB or sodium borohydride).

In various exemplary embodiments, the use of carbon monoxide make these well-designed shape-control synthetic processes can not only in organic solutions but also in aqueous solutions. That means that choice of solvent is broaden and “greener”, not restricted by the reducing reagent, broadening the choices of metal precursors and capping agents. In various exemplary embodiments, a new general approach for making shape well-defined noble metal-based nanoparticles both in organic solvent (oleylamine, diphenyl ether) and in aqueous solvent [deionized water (DI-H₂O)], such as cubic and octahedral Pt-based catalytic nanoparticles are provided. In various other exemplary embodiments, the new gas-reducing technique for synthesizing the well-shape-defined noble metal-based alloys with the broad size range (from tens of nanometers to hundreds of nanometers) such as cubic Pt, PtNi, PtFe, Pt₃Co, PtPd nanoparticles with the size of 15 nm, are provided. Exemplary nanoparticles obtained by employing exemplary methods according to the present invention have demonstrated superiority in comparison with known, widely-used fuel cell catalysts. Finally, in various exemplary embodiments, the edges of cubic nanoparticles are etched in situ in solution to form star-like multipods or octopods, or concave cubes.

In various exemplary embodiments, methods of forming shape-defined noble metal-based alloy catalytic nanoparticles are provided. Exemplary methods include: combining a convertible catalytic precursor and an optional solvent to form a reaction mixture; heating the reaction mixture to form a reaction solution; and maintaining a temperature of the heated reaction solution to form shape-defined noble metal-based alloy catalytic nanoparticles.

In various exemplary embodiments, shape-defined nanoparticles including catalytic materials are provided. Exemplary nanoparticles are cubic, truncated octahedron, octahedron, truncated tetrahedron, tetrahedron, icosahedral, rod, porous wire and multipod in shape and their concave shapes.

Pt-based cubic nanoparticles with the size of around 10 nm showed the enhanced catalytic activity of oxygen reduction reaction (ORR). AuPt metal alloys also show activity in oxygen evolution reactions (OER). ORR and OER are important reactions in low temperature fuel cells and batteries.

This invention presents a new selective gas-reducing technique, which represents a new concept for shape-control of nanoparticles. The shape-defined catalytic nanoparticles synthesized by the reducing gas described herein provide a general approach to the preparation of shape well-defined metal-containing nanoparticles. By avoiding the use of solid or liquid reducing reagents, the gas reducing reagent can be effectively and, in our cases, specifically delivered to the growing nanoparticle surfaces to promote or inhibit the growth of certain facets leading to the high level controls with much reduced mass transfer issues associated with solid and liquid phase reducers. Therefore, the level of shape control is much improved by using gas phase reducers such as carbon monoxide. Furthermore, these gas phase reactants also produce gas phase by-products which readily vaporize and leave the solution after the reaction. Thus, further washing process including surface treatment becomes unnecessary or greatly simplified. Thus, this process can also potentially be readily used in the industrial application. It is worthwhile to note that with reducing gases the reduction reaction happens only when the reducing gas adsorbs on the reacting surfaces. Therefore, reducing gas has effect of selective reducing rate on the different faces, which make it possible to control the shape, even with the weak capping agent, because most of reducing gas such as CO, H₂, NH₃, have preferential adsorption on the specific facet. The weak capping reagent herein is used also for preventing nanoparticles from aggregation, which makes the further removing the capping reagents (surface treatment) easier. These benefits developed with this new selective gas-reducing technique will result in the development of new concept for shape-control of nanoparticles based on the new concepts of tuning the reducing rate on different facets, while other methods use capping reagents tune the rate of crystal growth by tuning surface energies of different facets. This selective gas-reducing technique should also be used in the morphology-controlled synthesis of nanoparticles with size ranging from nanometer to sun-micron. The well-designed shape of Pt-based alloy nanoparticles with the most catalytic active facet exposed is expected to show much enhancement in the catalytic activity.

In various exemplary embodiments, the truncated octahedral, truncated tetrahedral, octahedral, tetrahedral, cubic, icosahedral, rod, porous wire and multipod noble-metal-based nanoparticles are formed by combining a convertible catalytic precursor and a solvent to form a reaction mixture; heating the reaction mixture to form a reaction solution; and maintaining a temperature of the heated reaction solution to form truncated octahedra, truncated tetrahedra, octahedra, tetrahedra and cubes. In various exemplary embodiments, nanoparticles may be formed of uniform metals, metal alloys or intermetallic compounds. Nanoparticles may be formed of metals that are derived from various precursors that can be reduced or that decompose to form such metals. In various exemplary embodiments, the new gas-reducing technique for shape well-defined metal-based catalytic nanoparticles both in organic solvents and aqueous solutions, such as cubic Pt, PtNi, PtFe, Pt₃Co, PtPd nanoparticles with the size of 15 nm, are provided.

Exemplary metal nanoparticles treated by the gas-reducing method include, but are not limited to, nanoparticles formed of one or more of platinum, palladium, gold, silver, nickel, cobalt, copper, iridium, ruthenium, iron and the like. Exemplary alloy nanoparticles treated by the ligand exchange method include, but are not limited to, nanoparticles formed from alloys including a first component having catalytic properties and one or more additional components. Exemplary first components for such alloys include, but are not limited to, platinum, palladium, gold, silver, nickel, copper, iridium and ruthenium. Exemplary additional components for such alloys include transition metals and combinations of transitions metals.

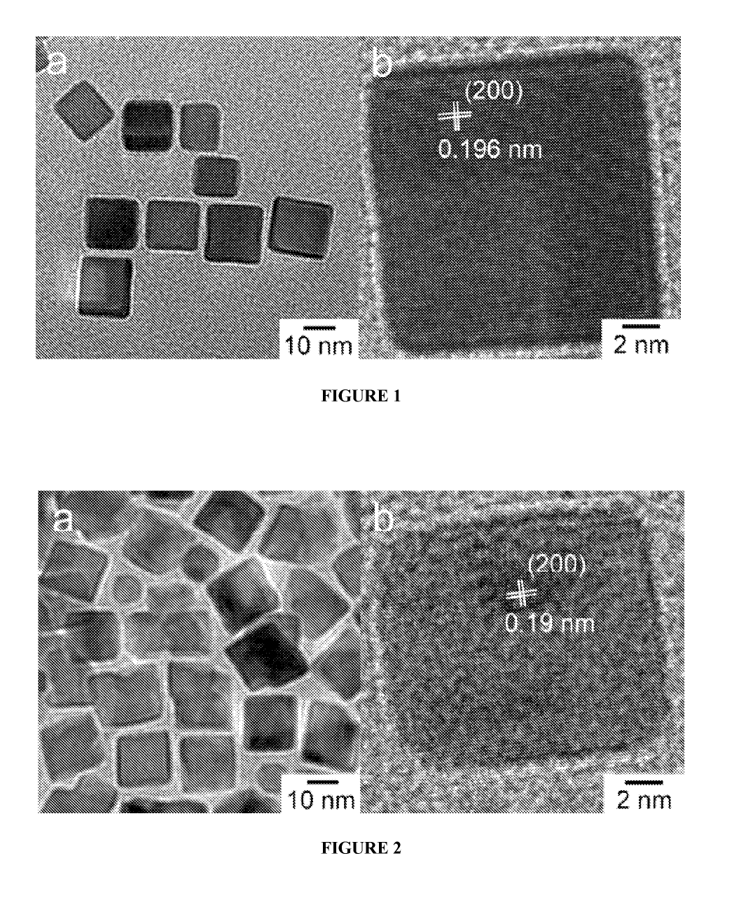

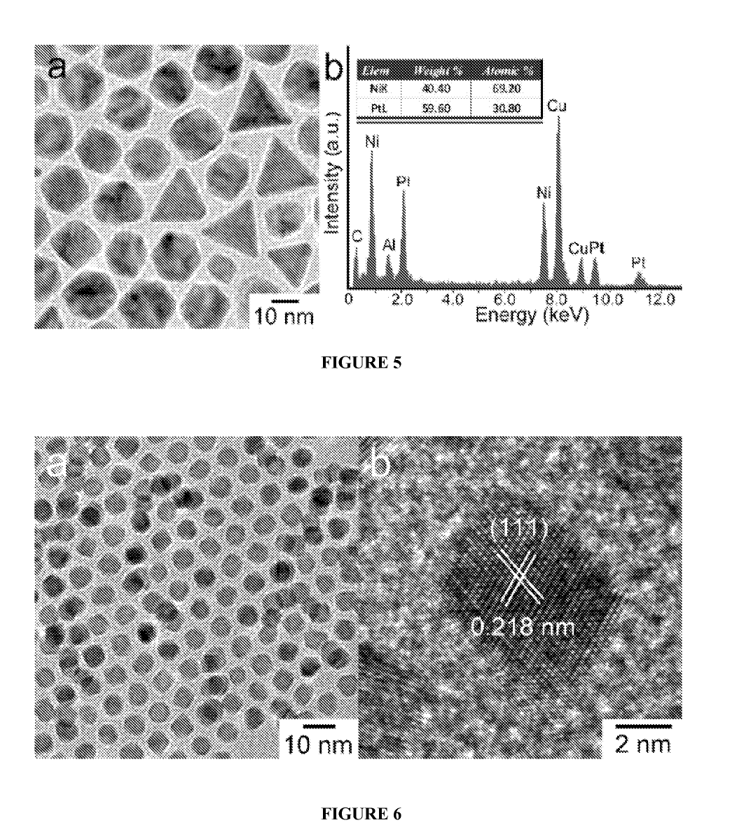

In various exemplary embodiments, nanoparticles have a truncated octahedral, octahedral, tetrahedral, or cubic shapes. Exemplary nanoparticles have specific facet exposed, e.g. cubic ((100) exposed), truncated octahedral and truncated tetrahedral ((111) and (100) exposed), and octahedral and tetrahedral ((111) exposed). Exemplary nanoparticles having the cubic shape with (100) specific facet exposed, are shown, e.g., in FIGS. 1-2, 8-11, 14; and exemplary nanoparticles having the octahedral and tetrahedral shape with (111) specific facet exposed, are shown, e.g., in FIGS. 5-7, 12, 16 and 17; exemplary nanoparticles having truncated octahedral and truncated tetrahedral shape with both (111) and (100) specific facets exposed, are shown, e.g. in FIGS. 4, 5, 13, 15 and 18, respectively. All of them are described in detail with respect to the examples set forth below. Unlike known spherical nanoparticles, the facet nanoparticles (e.g., cube and truncated octahedron) described herein, which are formed through anisotropic growth by blocking or promoting the specific face growth with capping agent, have some surfactant(s) on catalytic surfaces, have better dispersity, have high catalytic activity and have a high shape stability. The prevalence of exposed catalytic material (i.e., catalytic nanoparticles with active faces exposed under surfactants protection) may facilitate enhanced catalytic properties. The nanoparticles described herein may also be synthesized to have uniformity in size and shape.

In various exemplary embodiments, the cubic and octahedral nanoparticles may have an overall diameter of about 10-17 nanometers. In some such embodiments, the cubic and truncated octahedral nanoparticles may have an overall diameter of about 10 nanometers. In still further embodiments, the cubic and truncated octahedral nanoparticles may have an overall diameter of about 20, about 30, about 40, about 50, about 60, about 80 or about 90 nanometers. However, sizes outside of these ranges can be prepared and used, as desired.

In various exemplary embodiments, the edges of cubic nanoparticles are etched to form star-like or the four-branched multipods during the time evolution, which is shown in FIGS. 2a and 10b.

As indicated above, nanoparticles structured as described herein may be obtained by combining a convertible catalytic precursor, some certain surfactants and an optional solvent to form a reaction mixture; heating the reaction mixture to form a reaction solution; and maintaining a temperature of the heated reaction solution to form shape-defined catalytic nanoparticles. The critical point in nanoparticles shape control is the control on the nuclei and the crystal growth steps, in which the surfactants including the capping molecules and templates play an important role. For examples, in various exemplary embodiments of truncated octahedral Pt₃M nanoparticles, short alkane-chain amines appears to favor the formation of {111} facets. On the other hand, the capping agent can avoid the as-synthesized nanoparticles aggregation and thus keep the good dispersal. Another more important issue for fuel cell catalysts is their treatment after the synthesis. It is well known that the catalytic reaction mainly occurred at the unsaturated atomic steps, ledges, and kinks on the surface of catalysts. Therefore, to keep the catalysts surface clean is necessary. Therefore, it is believed that reducing gas has effect of selective reducing rate on the different faces, which make it possible to control the shape, even with the weak capping agent, because most of reducing gas such as CO, H₂, NH₃, have preferential adsorption on the specific facet. Therefore, the weak capping reagent herein is used largely for preventing nanoparticles from aggregation, which makes the further removing the capping reagents (surface treatment) easier.

In various exemplary embodiments, reducible precursors may include any suitable metal salt including a metal having catalytic properties. For example, reducible salt precursors for preparing platinum nanoparticles may include, but are not limited to, metal salts such as Pt(acac)₂ (acac=acetylacetonate, CH₃COCHCOCH₃ anion), platinum(IV) chloride, platinum(II) hexafluoroacetylacetonate, platinum(II) bromide, potassium hexachloroplatinate(IV), sodium hexachloroplatinate(IV) hexahydrate, and sodium tetrachloroplatinate(II) tetrahydrate.

In embodiments where a reducible precursor is employed, any suitable reducing gas may be used, so long as the agent is capable of facilitating the yield of a catalytic metal from the reducible precursor. Exemplary reducing gases include, but are not limited to, one or more of carbon monoxide (CO) and its derivatives, hydrogen (H₂), ammonia gas (NH₃), ozone (O₃), peroxide (H₂O₂), hydrogen sulfide (H₂S) and ethylenediamine. A surfactant may also be included in the reaction mixture. Any suitable surfactant or mixture of surfactants may be used, so long as at least one of the surfactants employed is capable of entrapment of nanoparticles. Polar functional groups of exemplary surfactants may include one or more of the following elements: nitrogen, oxygen, phosphorus, sulfur, chlorine, bromine and hydrogen. Exemplary surfactants may include long chain amines (e.g., having chains 8 or more carbons in length), such as hexadecylamine and long chain carboxylic acids such as oleic acid and 1,2 adamantanecarboxylic acid. Platinum nanoparticles may be prepared, for example, by using a combination of a reducible precursor, 1,2-hexadecane diol, hexadecylamine and 1,2 adamantanecarboxylic acid.

In various exemplary embodiments, optional solvents may include aqueous solution and any organic solvents capable of dissolving surfactants and reducible salt precursors at elevated temperatures. Exemplary organic solvents may include, but are not limited to, one or more of oleylamine, octadecylamine, hexadecylamine, dodecylamine, diphenyl ether, dioctyl ether and various glycols. Cubic platinum nanoparticles may be prepared, for example, by using oleylamine.

Combining a convertible catalytic precursor and an optional solvent to form a reaction mixture, as described above, can be performed by any suitable method, so long as the reaction mixture can be subjected to the elevated heat necessary to complete synthesis. For example, in preparing cubic platinum nanoparticles, surfactants, reducible (or decomposable) salt precursors, reducing reagents and organic solvents can be combined to form a reaction mixture in a container, such as a glass flask, reaction vessel or the like.

Heating the reaction mixture to form a reaction solution, as described above, can be performed by any suitable method, provided that the elements of the reaction mixture form a solution. The means used to heat the reaction mixture are limited only by the particular reactants (e.g., surfactants, reducible salt precursors, reducing reagents and/or organic solvents) and the temperature necessary to convert the reactants into a reaction solution. For example, if the reactants include oleylamine, oleic acid, and Pt(acac)₂ stored in a glass flask, it might be appropriate to use a glycol bath to heat the reactants. Further, it might be appropriate to heat the mixture to a temperature of between about 120° C. and 140° C., or about 130° C., to achieve solution, and then continuously heat to 210° C.

Maintaining a temperature of the heated reaction solution to form cubic and truncated octahedral nanoparticles, as described above, can be performed by any suitable method, provided that shape-defined catalytic nanoparticles are yielded from the reaction solution. The means used to maintain the temperature of the reaction solution are limited only by the particular reaction solution and the temperature necessary to yield shape-defined catalytic nanoparticles. For example, if the reaction solution is comprised of oleylamine, oleic acid, and Pt(acac)₂ stored in a glass flask, it might be appropriate to maintain the temperature of the solution in an oil bath, such as a glycol or glycerol bath. Further, it might be appropriate to maintain the mixture at a temperature of between about 200° C. and 230° C., or about 210° C., to yield shape-defined catalytic nanoparticles.

In various exemplary embodiments, hyper-branched Pt-based multipods and truncated octahedral Pt₃M nanoparticles are formed by combining a convertible catalytic precursor and an optional solvent to form a reaction mixture; heating the reaction mixture to form a reaction solution; and maintaining a temperature of the heated reaction solution to form hyper-branched multipod catalytic nanoparticles and truncated octahedra. In various exemplary embodiments, nanoparticles may be formed of uniform metals, metal alloys or intermetallic compounds. Nanoparticles may be formed of metals that are derived from various precursors that can be reduced or that decompose to form such metals. In various exemplary embodiments, the new ligand-exchange technique for room-temperature surface treatment of shape-defined catalytic nanoparticles, such as self-supporting hyper-branched multipods and truncated octahedral, are provided. The ligand with shorter alkyl chain can still maintain the shape and dispersal of catalytic nanoparticles and markedly make the surface more active.

Exemplary metal nanoparticles treated by the ligand exchange method include, but are not limited to, nanoparticles formed of one or more of platinum, palladium, gold, silver, nickel and copper. Exemplary alloy nanoparticles treated by the ligand exchange method include, but are not limited to, nanoparticles formed from alloys including a first component having catalytic properties and one or more additional components. Exemplary first components for such alloys include, but are not limited to, platinum, palladium, gold, silver, nickel, copper, iridium and ruthenium. Exemplary additional components for such alloys include transition metals and combinations of transitions metals.

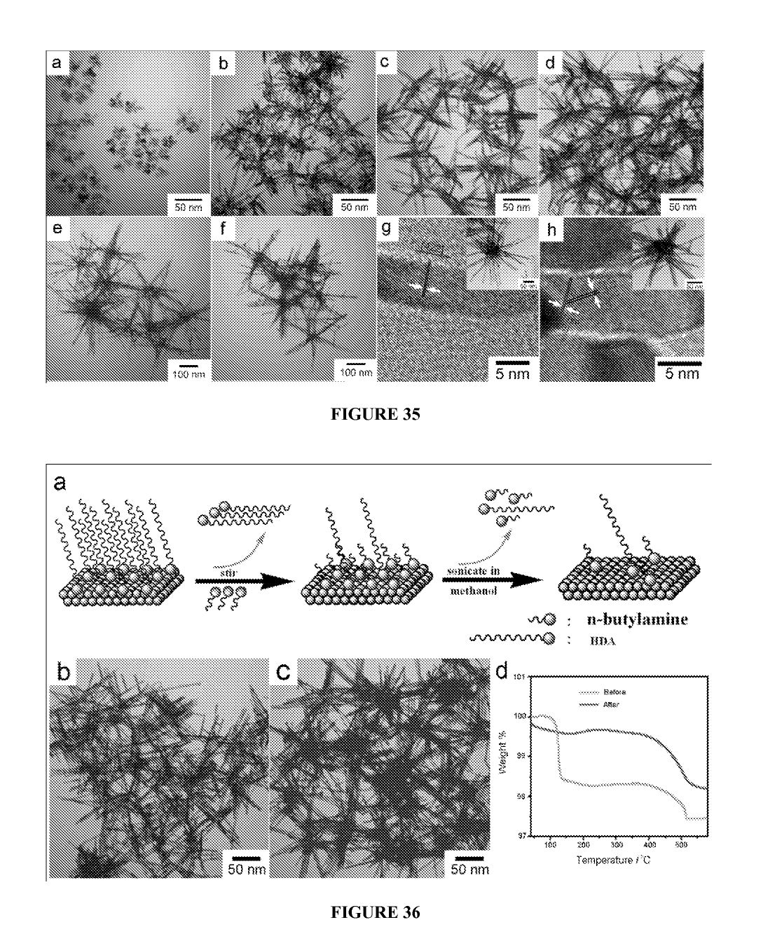

In various exemplary embodiments, nanoparticles have a rod-like shape, truncated octahedral and cubic shapes. Exemplary nanoparticles have a hyper-branched multipods structure. That is, exemplary nanoparticles may include numerous branches that provide a network-like shape. The numerous branches may be interconnected, providing a system of nano-network, which is self-supporting, avoiding nanoparticles aggregated and provides a medium or a path way for elections to transfer among nanoparticles or crystal domains much easier than nanoparticles without carbon support. Exemplary nanoparticles having this network-like shape are shown, e.g., in FIGS. 35(b-h) and 36 (b-c), described in detail with respect to the Examples set forth below. Unlike known carbon-supported platinum based catalysts, the nanoparticles (e.g., hyper-branched platinum multipods) described herein, which are formed through self anisotropic growth and self-assembled to form porous networks, have better connectivity, have a high structural stability and have less carbon corrosion issue. The prevalence of exposed catalytic material (i.e., catalytic material not coated or obscured by surfactant) may facilitate enhanced catalytic properties. The nanoparticles described herein may also be synthesized to have uniformity in size and shape, which may assist in the assembly of densely packed catalysts.

In various exemplary embodiments, the branches of the multipods may grow from about 4 to 6 nanometers in diameter, and from about 20 to about 220 nanometers in length during the time evolution.

In various exemplary embodiments, nanoparticles have a truncated octahedral or cubic shapes. Exemplary nanoparticles have specific facet exposed, e.g. cubic ((100) exposed), truncated octahedral (111) and (100) exposed). Exemplary nanoparticles having the cubic and truncated octahedral shapes with specific facet exposed are described in the examples set forth herein. Unlike known spherical nanoparticles, the facet nanoparticles (e.g., cube and truncated octahedron) described herein, which are formed through anisotropic growth by blocking the specific face growth with capping agent, have some surfactant(s) on catalytic surfaces, have better dispersal, have high catalytic activity and have a high shape stability. The prevalence of exposed catalytic material (i.e., catalytic nanoparticles with active faces exposed under surfactants protection) may facilitate enhanced catalytic properties. The nanoparticles described herein may also be synthesized to have uniformity in size and shape.

In various exemplary embodiments, the cubic and truncated octahedral nanoparticles may have an overall diameter of about 6 nanometers. In some such embodiments, the cubic and truncated octahedral nanoparticles may have an overall diameter of about 4 nanometers. In still further embodiments, the cubic and truncated octahedral nanoparticles may have an overall diameter of about 2, about 3, about 5, about 7, about 8, about 9 or about 10 nanometers. However, sizes outside of these ranges can be prepared and used, as desired.

As indicated above, nanoparticles structured as described herein may be obtained by combining a convertible catalytic precursor, some certain surfactants and an optional solvent to form a reaction mixture; heating the reaction mixture to form a reaction solution; and maintaining a temperature of the heated reaction solution to form shape-defined catalytic nanoparticles. The critical point in nanoparticles shape control is the control on the nuclei and the crystal growth steps, in which the surfactants including the capping molecules and templates play an important role. For examples, in various exemplary embodiments, the growth of multipods are attributed to the competitive binding of ACA and HDA on the surface of crystals and at the same time, the ACA amount is found critical to the Pt crystals growth. The extraordinary role of ACA resulted from the bulky adamantly end groups. Compared with the molecules with linear chains, such as fatty acid or amine, the adamantly groups protect a number of free surface sites from being occupied by the linear molecules and make this free surface energy increase, which induces the faster growth of such surfaces. As a result, the branches keep growth along the certain facet until the Pt precursor is consumed and the Ostwald Ripening dominates the anisotropic growth which leads to the transition of nanoparticles from multipods to spherical ones. In various exemplary embodiments of truncated octahedral Pt₃M nanoparticles, short alkane-chain amines appears to favor the formation of {111} facets. On the other hand side, the capping agent can avoid the as synthesized nanoparticles aggregation and thus keep the good dispersal. Another more important issue for fuel cell catalysts is their treatment after the synthesis. It is well known that the catalytic reaction mainly occurred at the unsaturated atomic steps, ledges, and kinks on the surface of catalysts. Therefore, to keep the catalysts surface clean is necessary. In order to get rid of the capping agents from the surface of nanoparticles, which is introduced during the synthesis, especially for the synthesis of nanoparticles with size and shape control in wet chemistry synthetic approach in a non-hydrolytic system. In various exemplary embodiments, butylamine is used in the room-temperature surface treatment to create carbon-supported and shape-defined active electrocatalysts. After the ligand exchange, the hyper-branched Pt multipods exhibit a high stability and electro catalytic activity toward ORR.

In various exemplary embodiments, reducible precursors may include any suitable metal salt including a metal having catalytic properties. For example, reducible salt precursors for preparing platinum nanoparticles may include, but are not limited to, metal salts such as Pt(acac)₂ (acac=acetylacetonate, CH₃COCHCOCH₃ anion), platinum(IV) chloride, platinum(II) hexafluoroacetylacetonate, platinum(II) bromide, potassium hexachloroplatinate(IV), sodium hexachloroplatinate(IV) hexahydrate, and sodium tetrachloroplatinate(II) tetrahydrate.

In embodiments where a reducible precursor is employed, any suitable reducing agent may be used, so long as the agent is capable of facilitating the yield of a catalytic metal from the reducible precursor. Exemplary reducing agents include, but are not limited to, one or more of 1,2-diols such as 1,2-hexadecane diol, other diols, such as ethylene lycol and boron hydrides. An optional surfactant may also be included in the reaction mixture. Any suitable surfactant or mixture of surfactants may be used, so long as at least one of the surfactants employed is capable of stabilizing nanoparticles. Polar functional groups of exemplary surfactants may include one or more of the following elements: nitrogen, oxygen, phosphorus, sulfur, chlorine, bromine and hydrogen. Exemplary surfactants may include long chain amines (e.g., having chains 8 or more carbons in length), such as hexadecylamine and long chain carboxylic acids such as oleic acid and 1,2-adamantanecarboxylic acid. Platinum nanoparticles may be prepared, for example, by using a combination of a reducible precursor, 1,2-hexadecane diol, hexadecylamine and 1,2 adamantanecarboxylic acid.

In various exemplary embodiments, optional solvents may include any organic solvents capable of dissolving surfactants and reducible salt precursors at elevated temperatures. Exemplary organic solvents may include, but are not limited to, one or more of diphenyl ether, dioctyl ether and various glycols. Platinum nanoparticles may be prepared, for example, by using diphenyl ether.

Combining a convertible catalytic precursor and an optional solvent to form a reaction mixture, as described above, can be performed by any suitable method, so long as the reaction mixture can be subjected to the elevated heat necessary to complete synthesis. For example, in preparing platinum nanoparticles, surfactants, reducible (or decomposable) salt precursors, reducing reagents and organic solvents can be combined to form a reaction mixture in a container, such as a glass flask, reaction vessel or the like.

Heating the reaction mixture to form a reaction solution, as described above, can be performed by any suitable method, provided that the elements of the reaction mixture form a solution. The means used to heat the reaction mixture are limited only by the particular reactants (e.g., surfactants, reducible salt precursors, reducing reagents and/or organic solvents) and the temperature necessary to convert the reactants into a reaction solution. For example, if the reactants include 1,2-hexadecane diol (HDD), hexadecylamine (HDA) and 1,2-adamantanecarboxylic acid (ACA), Pt(acac)₂ and diphenyl ether (DPE) stored in a glass flask, it might be appropriate to use a heating mantle to heat the reactants. Further, it might be appropriate to heat the mixture to a temperature of between about 160° C. and 180° C., or about 170° C., to achieve solution.

Maintaining a temperature of the heated reaction solution to form hyperbranched multipods and truncated octahedral nanoparticles, as described above, can be performed by any suitable method, provided that shape-defined catalytic nanoparticles are yielded from the reaction solution. The means used to maintain the temperature of the reaction solution are limited only by the particular reaction solution and the temperature necessary to yield shape-defined catalytic nanoparticles. For example, if the reaction solution is comprised of 1,2-hexadecane diol (HDD), hexadecylamine (HDA) and 1,2 adamantanecarboxylic acid (ACA), Pt(acac)₂ and diphenyl ether (DPE) stored in a glass flask, it might be appropriate to maintain the temperature of the solution in an oil bath, such as a glycol or glycerol bath. Further, it might be appropriate to maintain the mixture at a temperature of between about 155° C. and 165° C., or about 160° C., to yield shape-defined catalytic nanoparticles.

The shape-defined catalytic nanoparticles after ligand exchange as a surface treatment described herein provide superior catalytic performance, in comparison with conventionally achieved catalytic nanoparticles. While not being bound to a particular theory, it is believed that the interconnected morphology of sintered three-dimensional channels, uniform size and shape, of nanoparticles obtained by the methods described herein, along with the capability of forming catalytic nanoparticles without the use of carbon-supports may contribute to the superior catalytic performance of the nanoparticles described herein. The well-designed shape of Pt-based alloy nanoparticles with the most catalytic active face exposed is believed to show great enhancement in the catalytic activity. The ligand exchange method, as an effective surface treatment, is described herein to remove the surfactants from the surface of nanoparticles and maintain the property-active morphologies and dispersal of nanoparticles. The hyper-branched and truncated octahedral Pt-based nanoparticles are believed to show the show greater improvements in catalytic properties including the activity and durability because most of the active surface are exposed stably after the effective ligand exchange.

While several exemplary reactions are described below using small amounts of various reactants to obtain small amounts of shape-defined catalytic nanoparticles, it should be appreciated that the exemplary reactions are scalable. That is, using the reaction schemes described herein, it should be possible to prepare large, commercially useful quantities of shape-defined catalytic nanoparticles.

### Example 1

### Synthesis of Platinum Cubes

In a standard procedure, Pt(acac)₂ (20 mg or 0.05 mmol), oleylamine (OAM) (9 mL) and oleic acid (OA) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 230° C. under CO gas at the flow rate of 190 cm³/min. The reaction time varied from 30 minutes to 160 minutes. The nanoparticles were separated by dispersing the reaction mixture with 8 mL of hexane and 10 mL of ethanol, followed by centrifugation at 5000 rpm for 5 minutes. This procedure was repeated three times to wash away the excess reactants and capping agents. The final particles were dissolved in hexane for further characterization.

Transmission electron microscopy specimens are prepared by dispersing 1 mg of reaction product in 1 mL of hexane. The dispersed reaction product is drop-cast onto a carbon-coated copper grid. Transmission electron microscopy (TEM) and high-resolution transmission electron microscopy (HR-TEM) images were taken on a FEI TECNAI F-20 field emission microscope at an accelerating voltage of 200 kV. The optimal resolution of this microscopy is 1 Å under TEM mode. Energy dispersive X-ray (EDX) analysis of particles was also carried out on a field emission scanning electron microscope (FE-SEM, Zeiss-Leo DSM982) equipped with an EDAX detector. Powder x-ray diffraction (PXRD) spectra are recorded with a Philips MPD diffractometer using a Cu K_{α} X-ray source (λ=1.5405 Å) at a scan rate of 0.013 2θ/s. TEM for all of the data provided in the examples herein was collected as described above, unless otherwise indicated.

FIG. 1 show TEM images of cubic Pt nanoparticles obtained at 230° C. for 30 minutes. The length of cube edge is around 17 nm, which is prefect cubic and has high crystallization. FIG. 1b shows the d-spacing of lattices is 0.196 nm, matching with (200) of Pt.

### Example 2

### Synthesis of PtNi Cubes

In a standard procedure, Pt(acac)₂ (13.3 mg or 0.033 mmol), Ni(acac)₂ (8.6 mg or 0.033 mmol), oleylamine (OAM) (9 mL) and oleic acid (OA) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 210° C. under CO gas at the flow rate of 190 cm³/min. The reaction time varied from 30 minutes to 160 minutes. The nanoparticles were separated by dispersing the reaction mixture with 8 mL of hexane and 10 mL of ethanol, followed by centrifugation at 5000 rpm for 5 minutes. This procedure was repeated three times to wash away the excess reactants and capping agents. The final particles were dissolved in hexane for further characterization.

FIG. 2 show TEM images of cubic PtNi nanoparticles obtained at 210° C. for 30 minutes. The length of cube edge is around 18 nm, which is prefect cubic and has high crystallization. FIG. 2b shows the d-spacing of lattices is 0.19 nm, matching with (200) of PtNi.

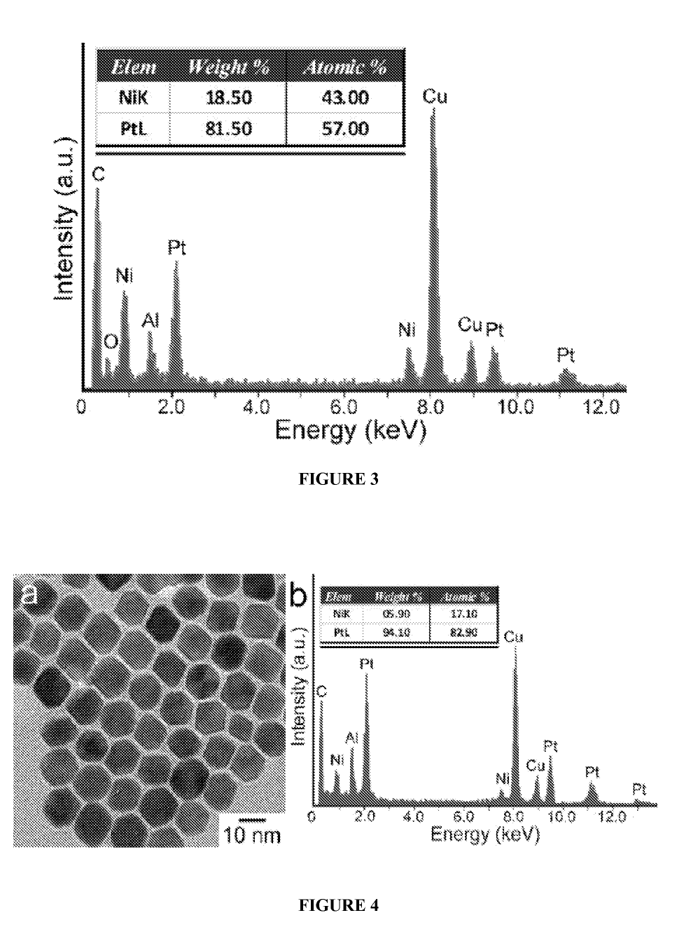

FIG. 3 shows energy dispersive X-ray (EDX) spectra of cubic PtNi nanoparticles obtained at 210° C. for 30 minutes. The Pt/Ni ratio is 57/43, which is close to the composition of PtNi.

### Example 3

### Synthesis of Pt₃Ni Truncated Octahedra

In a standard procedure, Pt(acac)₂ (20 mg or 0.05 mmol), Ni(acac)₂ (4.29 mg or 0.0167 mmol), oleylamine (OAM) (9 mL) and oleic acid (OA) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 210° C. under CO gas at the flow rate of 190 cm³/min. The reaction time varied from 30 minutes to 160 minutes. The nanoparticles were separated by dispersing the reaction mixture with 8 mL of hexane and 10 mL of ethanol, followed by centrifugation at 5000 rpm for 5 minutes. This procedure was repeated three times to wash away the excess reactants and capping agents. The final particles were dissolved in hexane for further characterization.

FIG. 4a shows TEM image of truncated octahedral Pt₃Ni nanoparticles obtained at 210° C. for 30 minutes. The length of truncated octahedral edge is around 12 nm, which has high crystallization.

FIG. 4b shows energy dispersive X-ray (EDX) spectra of truncated octahedral Pt₃Ni nanoparticles obtained at 210° C. for 30 minutes. The Pt/Ni ratio is 82.9/17.1, which is close to the composition of Pt₃Ni.

### Example 4

### Synthesis of PtNi₃ Truncated Octahedron and Tetrahedron

In a standard procedure, Pt(acac)₂ (8 mg or 0.0167 mmol), Ni(acac)₂ (12.9 mg or 0.05 mmol), oleylamine (OAM) (9 mL) and oleic acid (OA) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 210° C. under CO gas at the flow rate of 190 cm³/min. The reaction time varied from 30 minutes to 160 minutes. The nanoparticles were separated by dispersing the reaction mixture with 8 mL of hexane and 10 mL of ethanol, followed by centrifugation at 5000 rpm for 5 minutes. This procedure was repeated three times to wash away the excess reactants and capping agents. The final particles were dissolved in hexane for further characterization.

FIG. 5a shows TEM image of truncated octahedral, octahedral and tetrahedral PtNi₃ nanoparticles obtained at 210° C. for 30 minutes. The length of truncated octahedral or octahedral edge is around 15 nm, and the distance from the corner to the edge of tetrahedron is 19 nm.

FIG. 5b shows energy dispersive X-ray (EDX) spectra of truncated octahedral, octahedral and tetrahedral PtNi₃ nanoparticles obtained at 210° C. for 30 minutes. The Pt/Ni ratio is 30.8/69.2, which is close to the composition of PtNi₃.

### Example 5

### Synthesis of Pt₃Ni Octahedra

In a standard procedure, Pt(acac)₂ (20 mg or 0.05 mmol), Ni(acac)₂ (4.29 mg or 0.0167 mmol), oleylamine (OAM) (9 mL) and diphenyl ether (DPE) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 210° C. under CO gas at the flow rate of 190 cm³/min. The reaction time varied from 30 minutes to 160 minutes. The nanoparticles were separated by dispersing the reaction mixture with 8 mL of hexane and 10 mL of ethanol, followed by centrifugation at 5000 rpm for 5 minutes. This procedure was repeated three times to wash away the excess reactants and capping agents. The final particles were dissolved in hexane for further characterization.

FIG. 6 show TEM images of octahedral Pt₃Ni nanoparticles obtained at 210° C. for 30 minutes. The size of particles is around 8 nm, which is prefect octahedral and has high crystallization. FIG. 6b shows the d-spacing of lattices is 0.218 nm, matching with (111) of Pt₃Ni.

### Example 6

### Synthesis of PtNi octahedra

In a standard procedure, Pt(acac)₂ (13.3 mg or 0.033 mmol), Ni(acac)₂ (8.6 mg or 0.033 mmol), oleylamine (OAM) (9 mL) and diphenyl ether (DPE) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 210° C. under CO gas at the flow rate of 190 cm³/min. The reaction time varied from 30 minutes to 160 minutes. The nanoparticles were separated by dispersing the reaction mixture with 8 mL of hexane and 10 mL of ethanol, followed by centrifugation at 5000 rpm for 5 minutes. This procedure was repeated three times to wash away the excess reactants and capping agents. The final particles were dissolved in hexane for further characterization.

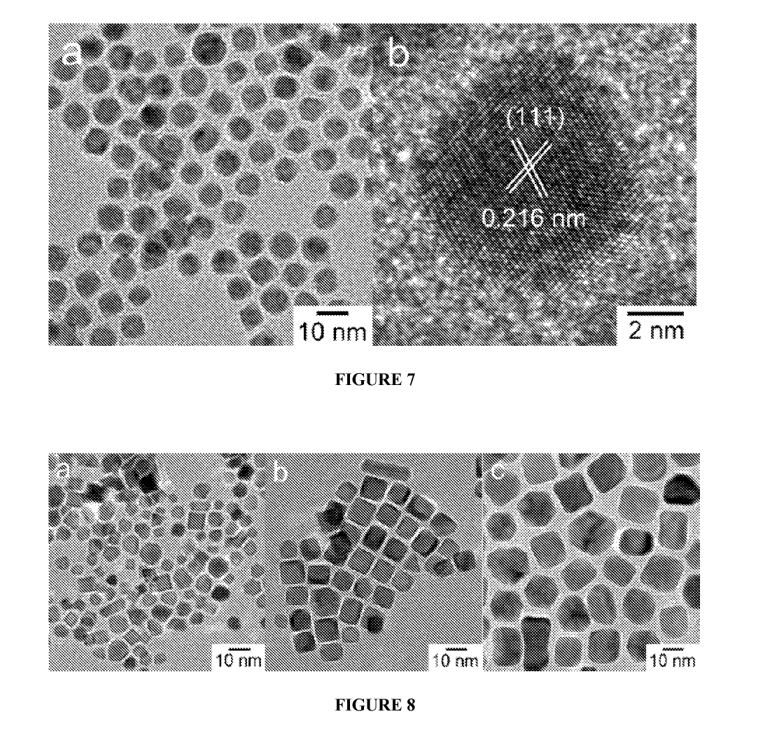

FIG. 7 show TEM images of octahedral PtNi nanoparticles obtained at 210° C. for 30 minutes. The size of particles is around 9 nm, which is prefect octahedral and has high crystallization. FIG. 7b shows the d-spacing of lattices is 0.216 nm, matching with (111) of PtNi.

### Example 7

### Synthesis of Size-Controllable Pt₃Ni Cubes

In a standard procedure, Pt(acac)₂ (50 mg or 0.126 mmol), Ni(acac)₂ (10.9 mg or 0.042 mmol), adamantaneacetic acid (AAA, Aldrich, 99%, 1.2 mmol), one of the following long alkane chain amines-dodecylamine (DDA, Aldrich, 98%, 8.28 mmol), hexadecylamine (HDA, TCI, 90% 8.28 mmol), or octadecylamine (ODA, Aldrich, 97%, 8.28% mmol)- and diphenyl ether (DPE, Aldrich, 90%, 4 ml) were mixed in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 210° C. under CO gas at the flow rate of 190 cm³/min. The reaction time varied from 30 minutes to 160 minutes. The nanoparticles were separated by dispersing the reaction mixture with 8 mL of chloroform and 10 mL of ethanol, followed by centrifugation at 5000 rpm for 5 minutes. This procedure was repeated three times to wash away the excess reactants and capping agents. The final particles were dissolved in chloroform for further characterization.

Transmission electron microscopy specimens are prepared by dispersing 1 mg of reaction product in 1 mL of chloroform. FIG. 8 show TEM images of size-controllable cubic Pt₃Ni nanoparticles made under three different sets of conditions. The size of Pt₃Ni cubes depends on the types and the lengths of alkane chain amines. Among the various amines, short alkane-chain amines appeared to favor the formation of small cubic nanocrystals. The cube with the size of ˜5 nm was observed when dodecylamine was used (FIG. 8a), and the cubic nanocrystals grows to ˜9 nm when hexadecylamine was chosen (FIG. 8b). Even larger cubic nanoparticles (˜15 nm, FIG. 8c) were obtained when octadecylamine was used, which is still smaller than that capped by oleylamine in oleylamine/oleic acid (˜18 nm, FIG. 2a).

### Example 8

### Synthesis of Pt₃Fe Cubes

In a standard procedure, Pt(acac)₂ (20 mg or 0.05 mmol), Fe(acac)₃ (5.89 mg or 0.0167 mmol), oleylamine (OAM) (9 mL) and oleic acid (OA) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 210° C. under CO gas at the flow rate of 190 cm³/min. The reaction time varied from 30 minutes to 160 minutes. The nanoparticles were separated by dispersing the reaction mixture with 8 mL of hexane and 10 mL of ethanol, followed by centrifugation at 5000 rpm for 5 minutes. This procedure was repeated three times to wash away the excess reactants and capping agents. The final particles were dissolved in hexane for further characterization.

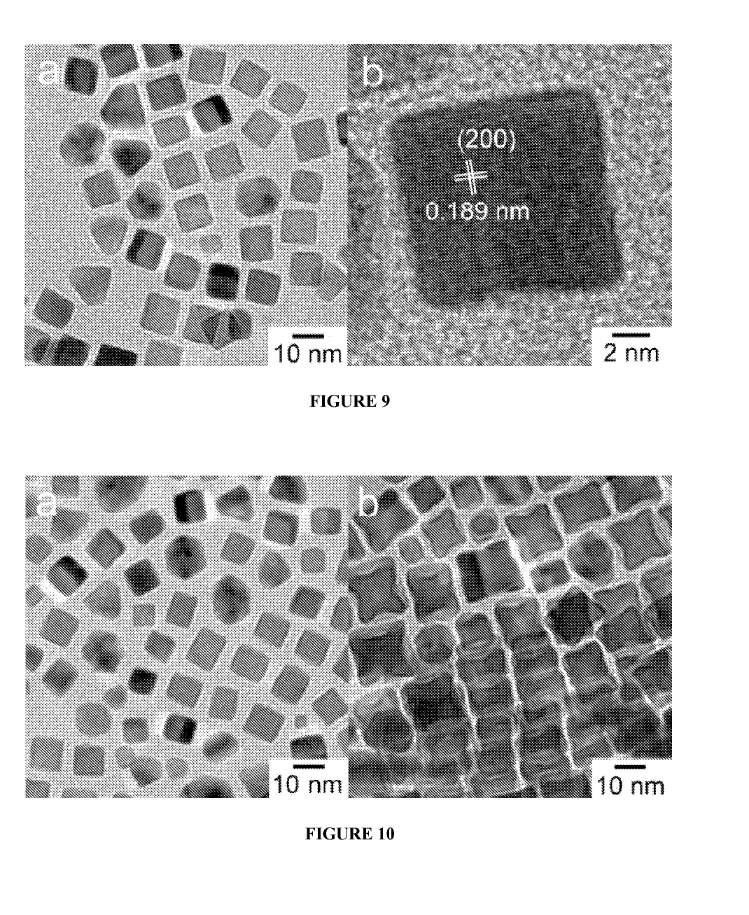

FIG. 9 show TEM images of cubic Pt₃Fe nanoparticles obtained at 210° C. for 30 minutes. The length of cube edge is around 11 nm, which is prefect cubic and has high crystallization. FIG. 9b shows the d-spacing of lattices is 0.189 nm, matching with (200) of Pt₃Fe.

### Example 9

### Synthesis of PtFe Cubes

In a standard procedure, Pt(acac)₂ (13.3 mg or 0.033 mmol), Fe(acac)₃ (11.8 mg or 0.033 mmol), oleylamine (OAM) (9 mL) and oleic acid (OA) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 210° C. under CO gas at the flow rate of 190 cm³/min. The reaction time varied from 30 minutes to 160 minutes. The nanoparticles were separated by dispersing the reaction mixture with 8 mL of hexane and 10 mL of ethanol, followed by centrifugation at 5000 rpm for 5 minutes. This procedure was repeated three times to wash away the excess reactants and capping agents. The final particles were dissolved in hexane for further characterization.

FIG. 10a shows TEM image of cubic PtFe nanoparticles obtained at 210° C. for 30 minutes. The length of cube edge is around 10 nm, which is prefect cubic and has high crystallization.

### Example 10

### Synthesis of PtFe₃ Cubes

In a standard procedure, Pt(acac)₂ (8 mg or 0.0167 mmol), Fe(acac)₃ (17.7 mg or 0.05 mmol), oleylamine (OAM) (9 mL) and oleic acid (OA) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 210° C. under CO gas at the flow rate of 190 cm³/min. The reaction time varied from 30 minutes to 160 minutes. The nanoparticles were separated by dispersing the reaction mixture with 8 mL of hexane and 10 mL of ethanol, followed by centrifugation at 5000 rpm for 5 minutes. This procedure was repeated three times to wash away the excess reactants and capping agents. The final particles were dissolved in hexane for further characterization.

FIG. 10b shows TEM image of cubic PtFe₃ nanoparticles obtained at 210° C. for 30 minutes. The length of cube edge is around 15 nm, which is prefect cubic and has high crystallization. It is interesting that some cubic nanoparticles are etched on the (200) faces to form the star-like structure or 4-branch multipods.

### Example 11

### Synthesis of Pt₃Co Cubes

In a standard procedure, Pt(acac)₂ (20 mg or 0.05 mmol), Co(acac)₂ (4.3 mg or 0.0167 mmol), oleylamine (OAM) (9 mL) and oleic acid (OA) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 210° C. under CO gas at the flow rate of 190 cm³/min. The reaction time varied from 30 minutes to 160 minutes. The nanoparticles were separated by dispersing the reaction mixture with 8 mL of hexane and 10 mL of ethanol, followed by centrifugation at 5000 rpm for 5 minutes. This procedure was repeated three times to wash away the excess reactants and capping agents. The final particles were dissolved in hexane for further characterization.

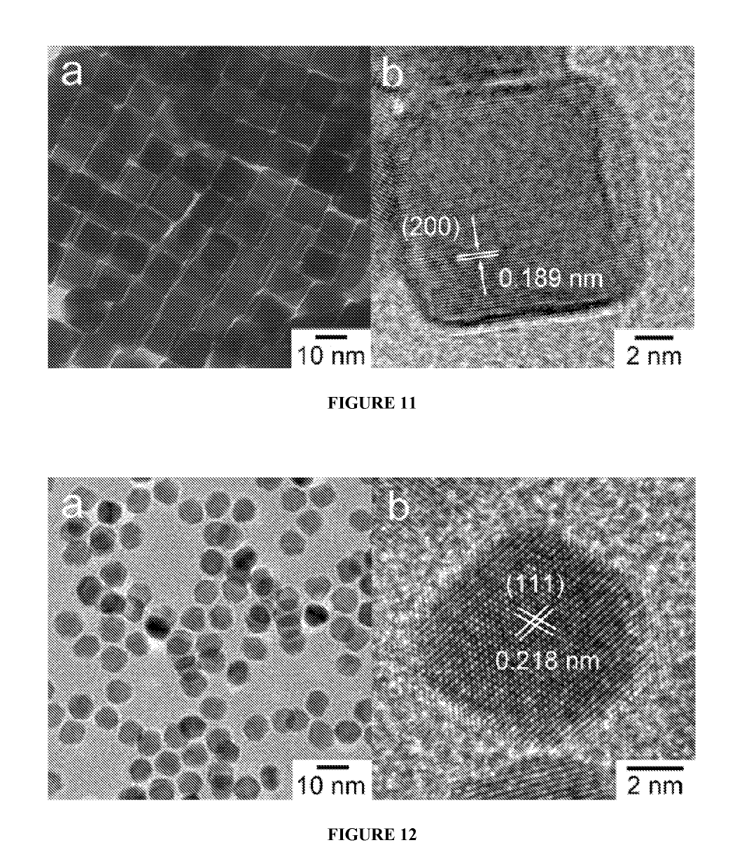

FIG. 11 show TEM images of cubic Pt₃Co nanoparticles obtained at 210° C. for 30 minutes. The length of cube edge is around 11 nm, which is prefect cubic and has high crystallization. FIG. 11b shows the d-spacing of lattices is 0.189 nm, matching with (200) of Pt₃Co.

### Example 12

### Synthesis of Pt₃Co Octahedra

In a standard procedure, Pt(acac)₂ (20 mg or 0.05 mmol), Co(acac)₂ (4.3 mg or 0.0167 mmol), oleylamine (OAM) (9 mL) and diphenyl ether (DPE) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 210° C. under CO gas at the flow rate of 190 cm³/min. The reaction time varied from 30 minutes to 160 minutes. The nanoparticles were separated by dispersing the reaction mixture with 8 mL of hexane and 10 mL of ethanol, followed by centrifugation at 5000 rpm for 5 minutes. This procedure was repeated three times to wash away the excess reactants and capping agents. The final particles were dissolved in hexane for further characterization.

FIG. 12 show TEM images of octahedral Pt₃Co nanoparticles obtained at 210° C. for 30 minutes. The size of particles is around 18 nm, which is prefect octahedral and has high crystallization. FIG. 12b shows the d-spacing of lattices is 0.218 nm, matching with (200) of Pt₃Co.

### Example 13

### Synthesis of Pt₃Cu Cube

In a standard procedure, Pt(acac)₂ (20 mg or 0.05 mmol), Cu(acac)₂ (4.3 mg or 0.0167 mmol), oleylamine (OAM) (9 mL) and oleic acid (OA) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 210° C. under CO gas at the flow rate of 190 cm³/min. The reaction time varied from 30 minutes to 160 minutes. The nanoparticles were separated by dispersing the reaction mixture with 8 mL of hexane and 10 mL of ethanol, followed by centrifugation at 5000 rpm for 5 minutes. This procedure was repeated three times to wash away the excess reactants and capping agents. The final particles were dissolved in hexane for further characterization.

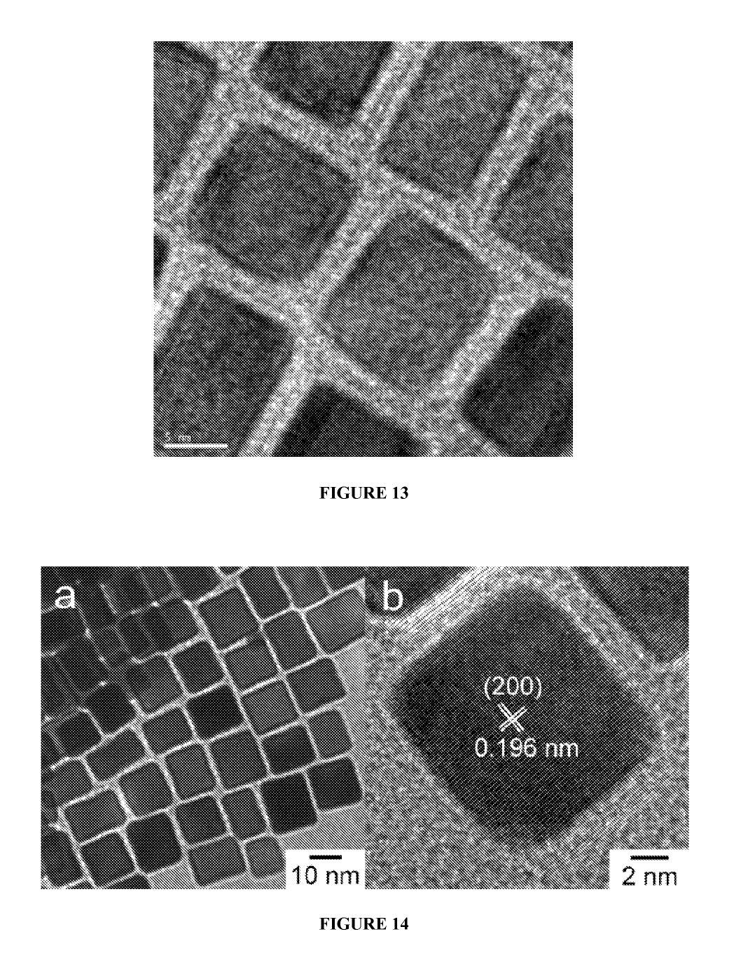

FIG. 13 shows TEM image of cubic Pt₃Cu nanoparticles obtained at 210° C. for 30 minutes. The size of particles is around 9 nm.

### Example 14

### Synthesis of PtPd Cubes

In a standard procedure, Pt(acac)₂ (20 mg or 0.05 mmol), Pd(acac)₂ (15.2 mg or 0.05 mmol), oleylamine (OAM) (9 mL) and oleic acid (OA) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 210° C. under CO gas at the flow rate of 190 cm³/min. The reaction time varied from 30 minutes to 160 minutes. The nanoparticles were separated by dispersing the reaction mixture with 8 mL of hexane and 10 mL of ethanol, followed by centrifugation at 5000 rpm for 5 minutes. This procedure was repeated three times to wash away the excess reactants and capping agents. The final particles were dissolved in hexane for further characterization.

FIG. 14 shows TEM images of cubic PtPd nanoparticles obtained at 210° C. for 30 minutes. The length of cube edge is around 14 nm, which is prefect cubic and has high crystallization. FIG. 14b shows the d-spacing of lattices is 0.196 nm, matching with (200) of PtPd.

### Example 15

### Synthesis of PtAu Truncated Octahedra

In a standard procedure, Pt(acac)₂ (20 mg or 0.05 mmol), HAuCl₄ (19.3 mg or 0.05 mmol), oleylamine (OAM) (9 mL) and oleic acid (OA) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 180° C. under CO gas at the flow rate of 190 cm³/min. The reaction time varied from 30 minutes to 160 minutes. The nanoparticles were separated by dispersing the reaction mixture with 8 mL of hexane and 10 mL of ethanol, followed by centrifugation at 5000 rpm for 5 minutes. This procedure was repeated three times to wash away the excess reactants and capping agents. The final particles were dissolved in hexane for further characterization.

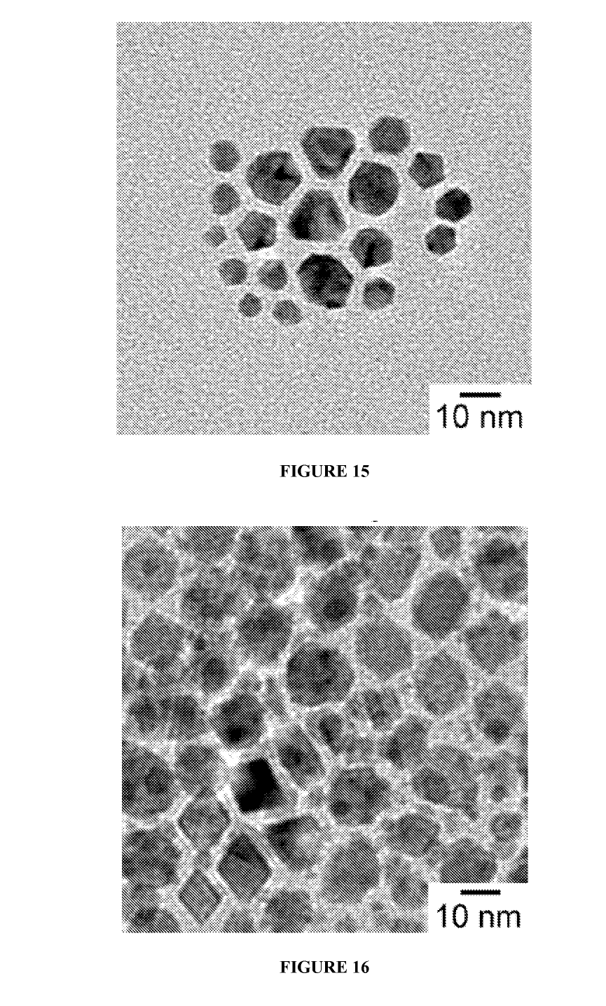

FIG. 15 shows TEM image of truncated octahedral PtAu nanoparticles obtained at 180° C. for 30 minutes. The average size of truncated octahedral PtAu nanoparticles is around 9 nm.

### Example 16

### Synthesis of PtAg Octahedra

In a standard procedure, Pt(acac)₂ (20 mg or 0.05 mmol), Ag strearate (19.6 mg or 0.05 mmol), oleylamine (OAM) (9 mL) and oleic acid (OA) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 180° C. under CO gas at the flow rate of 190 cm³/min. The reaction time varied from 30 minutes to 160 minutes. The nanoparticles were separated by dispersing the reaction mixture with 8 mL of hexane and 10 mL of ethanol, followed by centrifugation at 5000 rpm for 5 minutes. This procedure was repeated three times to wash away the excess reactants and capping agents. The final particles were dissolved in hexane for further characterization.

FIG. 16 shows TEM image of octahedral PtAg nanoparticles obtained at 180° C. for 30 minutes. The average size of octahedral PtAg nanoparticles is around 12 nm.

### Example 17

### Synthesis of Pt₃Ni Icosahedra

In a standard procedure, Pt(acac)₂ (8 mg or 0.017 mmol), Ni(acac)₂ (12.9 mg or 0.05 mmol), oleylamine (OAM) (9 mL) and oleic acid (OA) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 210° C. under CO gas at the flow rate of 190 cm³/min. The reaction time varied from 30 minutes to 160 minutes. The nanoparticles were separated by dispersing the reaction mixture with 3 mL of chloroform and 20 mL of ethanol, followed by centrifugation at 12000 rpm for 5 minutes. This procedure was repeated three times to wash away the excess reactants and capping agents. The final particles were dissolved in hexane for further characterization.

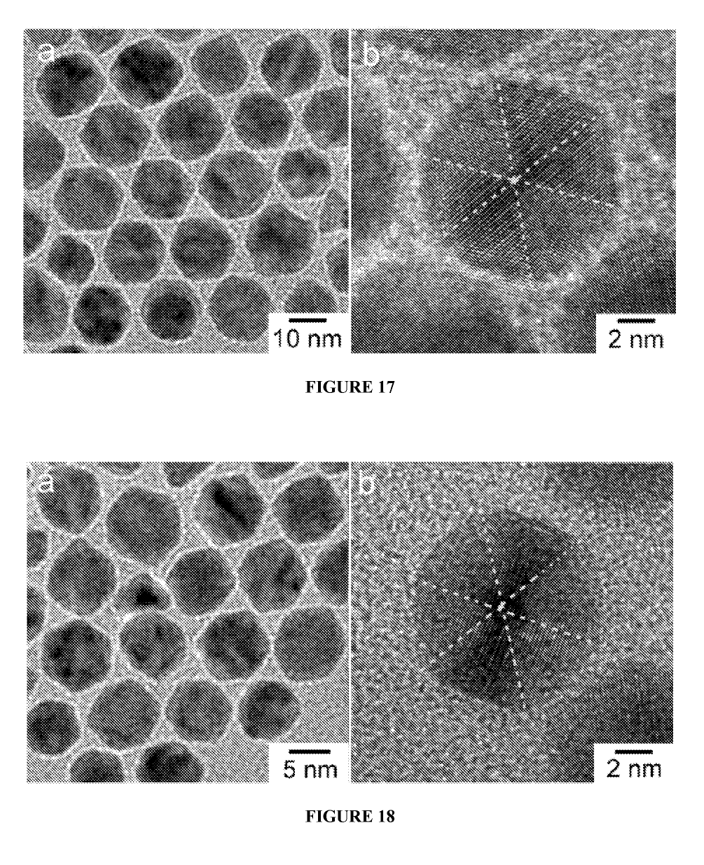

FIG. 17 shows TEM image of icosahedral Pt₃Ni nanoparticles obtained at 210° C. for 30 minutes. The average size of icosahedral Pt₃Ni nanoparticles is around 12 nm.

### Example 18

### Synthesis of Pt₃Pd Icosahedra

In a standard procedure, Pt(acac)₂ (0.05 mmol), Pd(acac)₂ (0.017 mmol), oleylamine (OAM) (9 mL) and diphenyl ether (DPE) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 210° C. under CO gas at the flow rate of 190 cm³/min. The reaction time varied from 30 minutes to 160 minutes. The nanoparticles were separated by dispersing the reaction mixture with 3 mL of chloroform and 20 mL of ethanol, followed by centrifugation at 12000 rpm for 5 minutes. This procedure was repeated three times to wash away the excess reactants and capping agents. The final particles were dissolved in hexane for further characterization.

FIG. 18 shows TEM image of icosahedral Pt₃Pd nanoparticles obtained at 210° C. for 30 minutes. The average size of icosahedral Pt₃Ni nanoparticles is around 12 nm.

### Example 19

### Synthesis of Pt₃Au Icosahedra

In a standard procedure, Pt(acac)₂ (0.05 mmol), HAuC14 (0.05 mmol), oleylamine (OAM) (9 mL) and oleic acid (OA) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 210° C. under CO gas at the flow rate of 190 cm³/min. The reaction time varied from 30 minutes to 160 minutes. The nanoparticles were separated by dispersing the reaction mixture with 3 mL of chloroform and 20 mL of ethanol, followed by centrifugation at 12000 rpm for 5 minutes. This procedure was repeated three times to wash away the excess reactants and capping agents. The final particles were dissolved in hexane for further characterization.

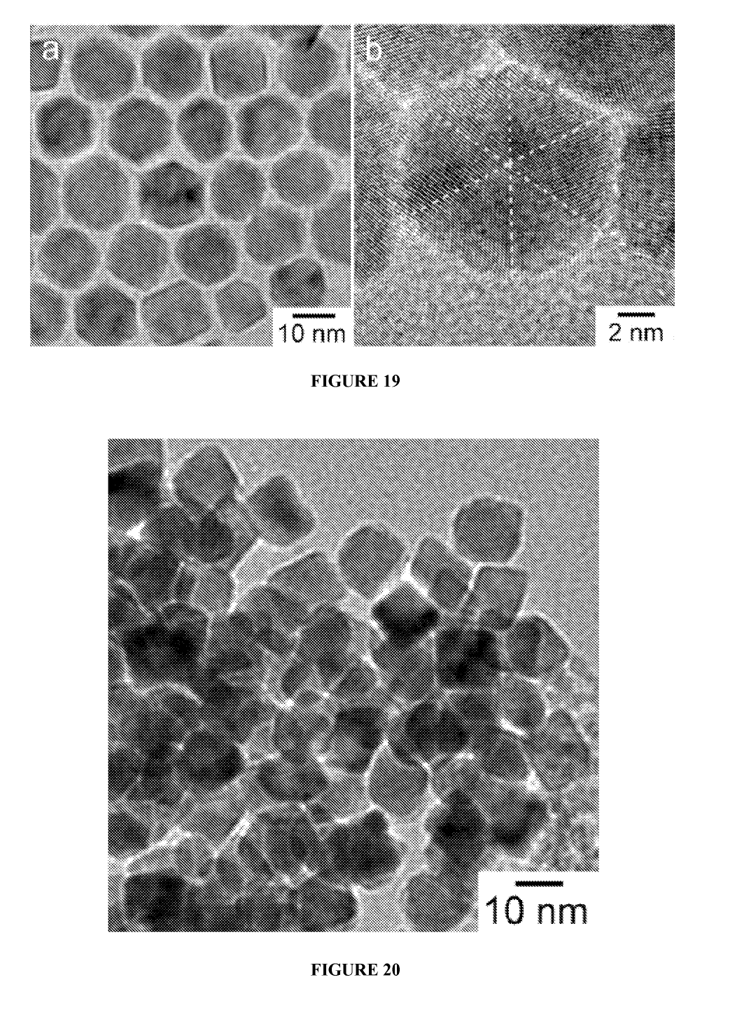

FIG. 19 shows TEM image of icosahedral Pt₃Au nanoparticles obtained at 210° C. for 30 minutes. The average size of icosahedral Pt₃Au nanoparticles is around 12 nm.

### Example 20

### Synthesis of Pd Octahedra in EG-PVP System

In a standard procedure, Pd(NO₃)₂ (11.5 mg or 0.05 mmol), polyvinylpyrrolidone (PVP) (MW=40000, 0.4 g or 0.01 mmol) and ethylene glycol (EG) (10 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 180° C. under CO gas at the flow rate of 190 cm³/min. The reaction time varied from 30 minutes to 160 minutes. The nanoparticles were separated by dispersing the reaction mixture with 8 mL of ethanol and 10 mL of DI-H₂O, followed by centrifugation at 5000 rpm for 5 minutes. This procedure was repeated three times to wash away the excess reactants and capping agents. The final particles were dissolved in ethanol for further characterization.

Transmission electron microscopy specimens are prepared as described above, except that 1 mg of reaction product was dispersed in 1 mL of ethanol. FIG. 20 shows TEM image of octahedral Pd nanoparticles obtained in EG-PVP system at 180° C. for 30 minutes. The average size of octahedral Pd nanoparticles is around 12 nm.

### Example 21

### Synthesis of Truncated Tetrahedral and Tetrahedral Au Nanoparticles in Aqueous Solution

In a standard procedure, HAuCl₄ (5.9 mg or 0.01 mmol), Cetyl trimethylammonium bromide (CTAB) (364.5 mg or 1 mmol) and DI-H₂O (10 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 90° C. under CO gas at the flow rate of 190 cm³/min, and the reaction mixture turned into a transparent yellowish solution at this temperature. The reaction time varied from 30 minutes to 160 minutes. The nanoparticles were separated by dispersing the reaction mixture with 8 mL of ethanol and 10 mL of DI-H₂O, followed by centrifugation at 5000 rpm for 5 minutes. This procedure was repeated three times to wash away the excess reactants and capping agents. The final particles were dissolved in ethanol for further characterization.

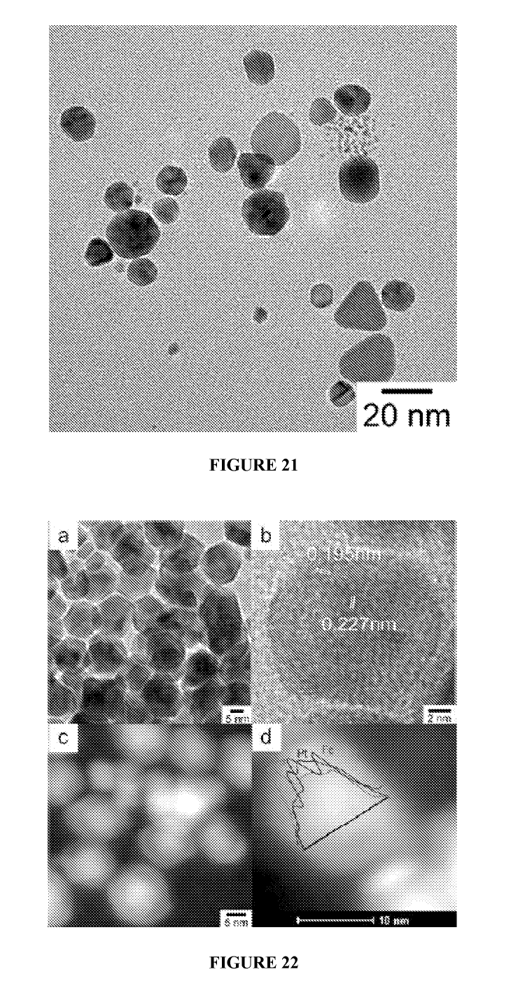

Transmission electron microscopy specimens are prepared by dispersing 1 mg of reaction product in 1 mL of ethanol. FIG. 21 shows TEM image of truncated tetrahedral and tetrahedral Au nanoparticles obtained in aqueous solution at 90° C. for 30 minutes. The average size of Au nanoparticles is around 18 nm.

### Example 22

### Synthesis of PtFe@PtPd Core-Shell Nanoparticles

PtFe truncated-octahedron core: In a standard procedure, Pt(acac)₂ (13.3 mg or 0.033 mmol), Fe(acac)₃ (11.9 mg or 0.033 mmol), oleylamine (OAM) (9 mL) and oleic acid (OA) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 210° C. for 30 seconds, and the reaction mixture was turned into a transparent red-brown solution at this temperature. The flask was then immersed in a glycerol bath again at 210° C. under CO gas at the flow rate of 112 cm³/min for 30 minutes. 5 mL of the product was transferred out for future use. Meanwhile, Pt(acac)₂ (20 mg or 0.05 mmol), Pd(acac)₂ (5.16 mg or 0.017 mmol), oleylamine (OAM) (9 mL) and oleic acid (OA) (1 mL) were mixed in a 16 mL vial, and immersed in a glycerol bath set at 210° C. for 30 seconds to get a transparent pink solution. The Pt—Pd solution was then injected into the 25 mL flask with PtFe nanoparticles. The flask was then immersed in the glycerol bath at 210° C. again under CO gas at the flow rate of 112 cm³/min for 30 minutes. The nanoparticles were separated by dispersing the reaction mixture with 3 mL of chloroform and 20 mL of ethanol, followed by centrifugation at 12000 rpm for 5 minutes. This procedure was repeated three times to wash away the excess reactants and capping agents. The final particles were dissolved in hexane for further characterization.

FIG. 22a shows TEM images of core-shell PtFe@PtPd nanoparticles obtained at 210° C. for 30 minutes. After coating, the nanoparticle size increased from ˜8 nm to ˜14 nm. Because Pd is heavier than Fe, obvious contrast is observed after coating. FIG. 22b shows the d spacing of the core is 0.227 nm, matching with (111) plane of PtFe alloy; the d spacing of the shell is 0.195 nm, matching with (200) plane of Pt₃Pd alloy. Better observation of core-shell structure is observed from high-angle annular dark-field scanning transmission electron microscopy (HAADF-STEM) image, shown in FIG. 22c. Truncated octahedron core and shell are clear to see. FIG. 22d shows linear profile of one core-shell nanoparticles. There are much more Pd distributing in the shell, and more Fe distributing in the core, while Pt exists in both core and shell.

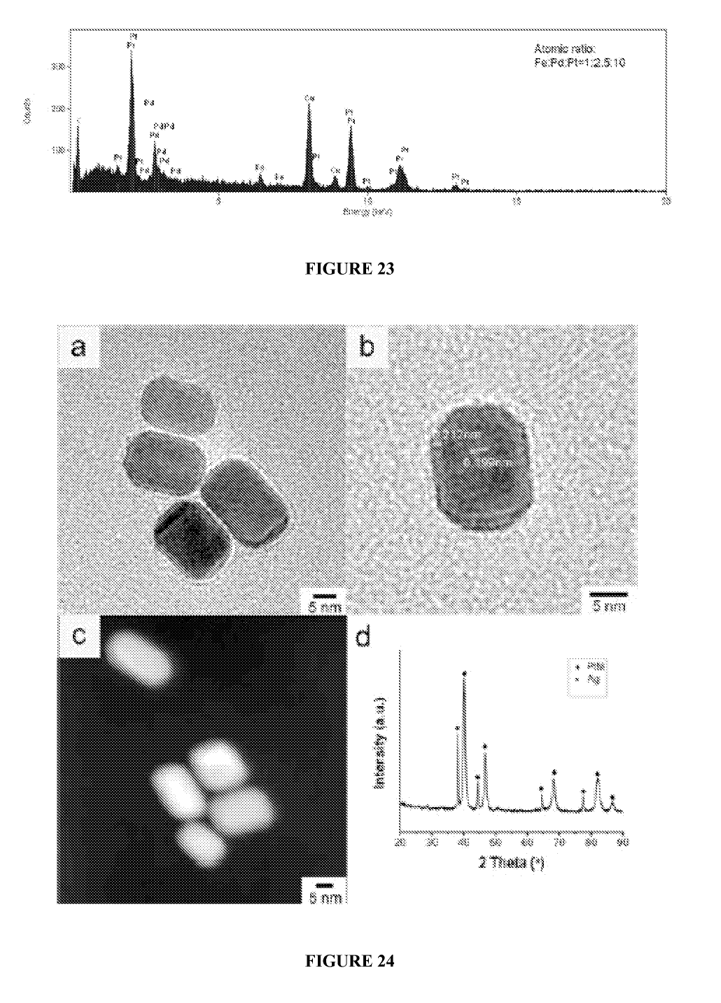

FIG. 23 shows energy dispersive X-ray (EDX) spectra of truncated octahedron core-shell PtFe@PtPd nanoparticles. The Fe/Pd/Pt ratio is 1:2.5:10, which are a little different from the compositional ratio (0.015:0.017:0.08).

### Example 23

### Synthesis of Ag@PtNi Core-Shell Nanoparticles

Synthesis of Ag truncated octahedron: In a standard procedure, Ag trifluoroacetate (11 mg or 0.05 mmol), oleylamine (OAM) (9 mL) and oleic acid (OA) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 60° C., and the reaction mixture turned into a transparent yellowish solution at this temperature. The flask was then transferred to a second glycerol bath set at a designed temperature at 180° C. under CO gas at the flow rate of 190 cm³/min. The reaction time varied from 30 minutes to 160 minutes. The nanoparticles were separated by dispersing the reaction mixture with 8 mL of hexane and 10 mL of ethanol, followed by centrifugation at 5000 rpm for 5 minutes. This procedure was repeated three times to wash away the excess reactants and capping agents. The final particles were dissolved in hexane for further characterization.

Synthesis of Ag@PtNi cubes: Pt(acac)₂ (0.033 mmol), Ni(acac)₂ (0.033 mmol), oleylamine (OAM) (9 mL) and oleic acid (OA) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 210° C. for 30 seconds, and the reaction mixture turned into a transparent yellowish solution at this temperature. Ag seed (0.033 mmol) was then added into the solution, followed by sonication, Ag seed was dispersed in the solution. The flask was then immersed again in the glycerol bath set at 210° C. under CO gas at the flow rate of 34 cm³/min for 30 minutes. The nanoparticles were separated by dispersing the reaction mixture with 3 mL of chloroform and 20 mL of ethanol, followed by centrifugation at 12000 rpm for 5 minutes. This procedure was repeated three times to wash away the excess reactants and capping agents. The final particles were dissolved in hexane for further characterization.

FIG. 24a shows TEM images of core-shell cubic Ag@PtNi nanoparticles obtained at 210° C. for 30 minutes. After coating, the nanoparticle size increased from ˜9 nm to ˜13 nm. FIG. 24b shows the d spacing of the core is 0.199 nm, matching with (200) plane of Ag; the d spacing of the shell is 0.212 nm, matching with (111) plane of PtNi alloy.

FIG. 24c shows STEM image of Ag@PtNi core-shell nanoparticles. Because the shell is much thinner than the core, the contrast is not as obvious as HRTEM. PXRD spectra showed in FIG. 24d observed both Ag and PtNi peaks. The peaks at 38.12°, 44.3°, 64.56°, and 77.5° are all indexed to (111), (200), (220), and (311) planes of face-centered-cubic (fcc) Ag. The peaks at 40.18°, 46.56°, 68.2°, 82.24°, and 86.86° can be indexed to (111), (200), (220), (311), and (222) planes of PtNi alloy. These peaks are a little red shift compared to Pt because the d spacing of Ni is a little smaller than that of Pt.

### Example 24

### Synthesis of AuAg Nanowires

In a standard procedure, HAuCl₄ (0.05 mmol) and Ag trifluoroacetate (0.05 mmol), oleylamine (OAM) (5 mL) and oleic acid (OA) (5 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 60° C., and the reaction mixture turned into a transparent yellowish solution at this temperature after 30 seconds. The flask was then transferred to a second glycerol bath set at a designed temperature at 60° C. under CO gas at the flow rate of 80 cm³/min without stirring. The reaction time varied from 30 minutes to 160 minutes. The nanoparticles were separated by dispersing the reaction mixture with 8 mL of chloroform and 10 mL of ethanol, followed by centrifugation at 5000 rpm for 5 minutes. This procedure was repeated three times to wash away the excess reactants and capping agents. The final particles were dissolved in chloroform for further characterization.

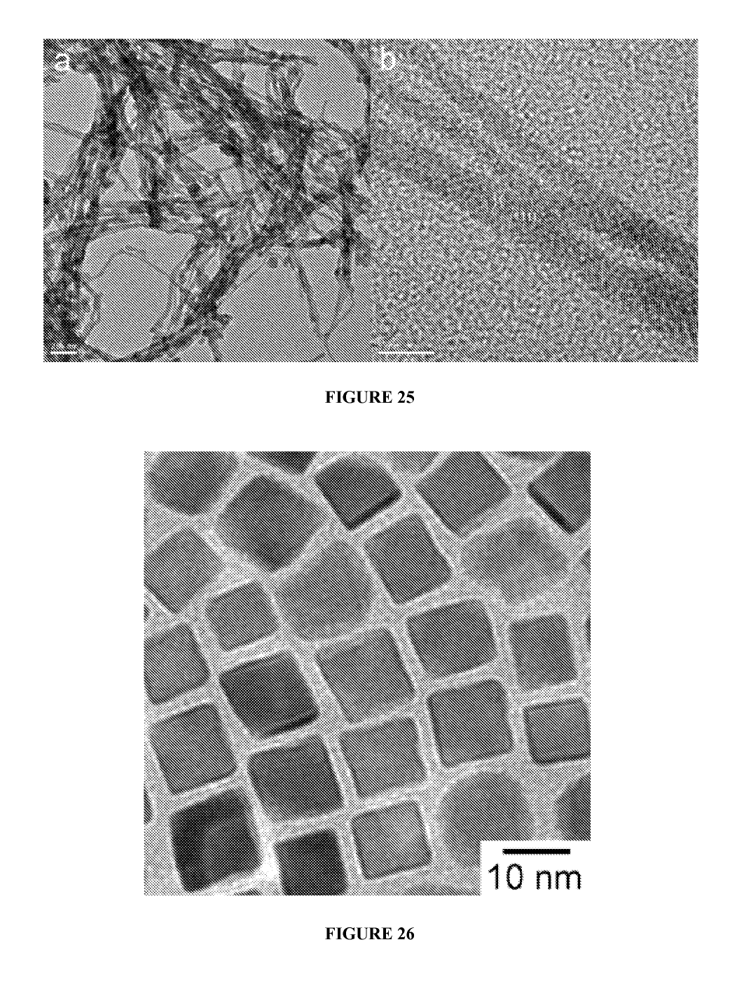

FIG. 25 shows TEM images of AuAg nanowires obtained at 210° C. for 30 minutes. The diameter of single wire is about 2-3 nm, which is face cubic center phase and has high crystallization. FIG. 25b shows the d-spacing of lattices is 0.234 nm, matching with (111) of AuAg.

### Example 25

### Synthesis of Pt₃Pd Cube by 5% H₂

In a standard procedure, Pt(acac)₂ (20 mg or 0.05 mmol), Pd(acac)₂ (5.2 mg or 0.017 mmol), oleylamine (OAM) (9 mL) and oleic acid (OA) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 210° C. under 5% H₂ gas at the flow rate of 190 cm³/min. The reaction time varied from 30 minutes to 160 minutes. The nanoparticles were separated by dispersing the reaction mixture with 3 mL of chloroform and 20 mL of ethanol, followed by centrifugation at 12000 rpm for 5 minutes. This procedure was repeated three times to wash away the excess reactants and capping agents. The final particles were dissolved in hexane for further characterization.

FIG. 26 shows TEM image of cubic Pt₃Pd nanoparticles obtained at 210° C. for 30 minutes by 5% H₂. The average size of cubic Pt₃Pd nanoparticles is around 8 nm.

### Example 26

### Synthesis of Pt Quad-Pod by 5% H₂

In a standard procedure, Pt(acac)₂ (20 mg or 0.05 mmol), oleylamine (OAM) (9 mL) and oleic acid (OA) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 180° C. under 5% H₂ gas at the flow rate of 190 cm³/min. The reaction time varied from 30 minutes to 160 minutes. The nanoparticles were separated by dispersing the reaction mixture with 3 mL of chloroform and 20 mL of ethanol, followed by centrifugation at 12000 rpm for 5 minutes. This procedure was repeated three times to wash away the excess reactants and capping agents. The final particles were dissolved in hexane for further characterization.

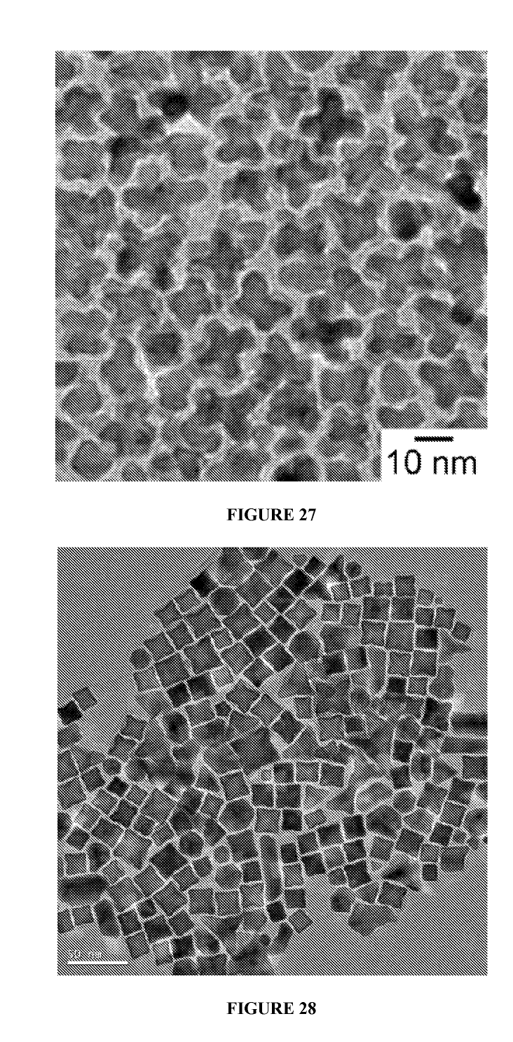

FIG. 27 shows TEM image of Pt quad-pods obtained at 210° C. for 160 minutes by 5% H₂. The average size of Pt quad-pods is around 15 nm with the diameter of 7 nm for each branch.

### Example 27

### Synthesis of Platinum Concave Cubes

In a standard procedure, Pt(acac)₂ (20 mg or 0.05 mmol), oleylamine (OAM) (9 mL) and oleic acid (OA) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 210° C. under CO gas at the flow rate of 190 cm³/min. The reaction time is 60 min. The nanoparticles were separated by dispersing the reaction mixture with 8 mL of chloroform and 10 mL of ethanol, followed by centrifugation at 5000 rpm for 5 min. This procedure was repeated three times to wash away the excess reactants and capping agents. The final particles were dissolved in chloroform for further characterization.

Transmission electron microscopy specimens are prepared as described above, except that 1 mg of reaction product was dispersed in 1 mL of chloroform. FIG. 28 shows TEM images of concave cubic Pt nanoparticles obtained at 210° C. for 1 hr. The length of concave cube edge is around 15 nm. The cubic seeds selectively overgrow form corners and edges (the <111> and <110> directions of fcc structures) to form a concave structure.

### Example 28

### Synthesis of PtNi Concave Cubes

In a standard procedure, Pt(acac)₂ (17 mg), Ni(acac)₂ (11 mg), oleylamine (OAM) (9 mL) and oleic acid (OA) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 210° C. under CO gas at the flow rate of 190 cm³/min. The reaction time is 120 min. The nanoparticles were separated by dispersing the reaction mixture with 3 mL of chloroform and 10 mL of ethanol, followed by centrifugation at 5000 rpm for 5 min. This procedure was repeated three times to wash away the excess reactants and capping agents. The final particles were dissolved in chloroform for further characterization.

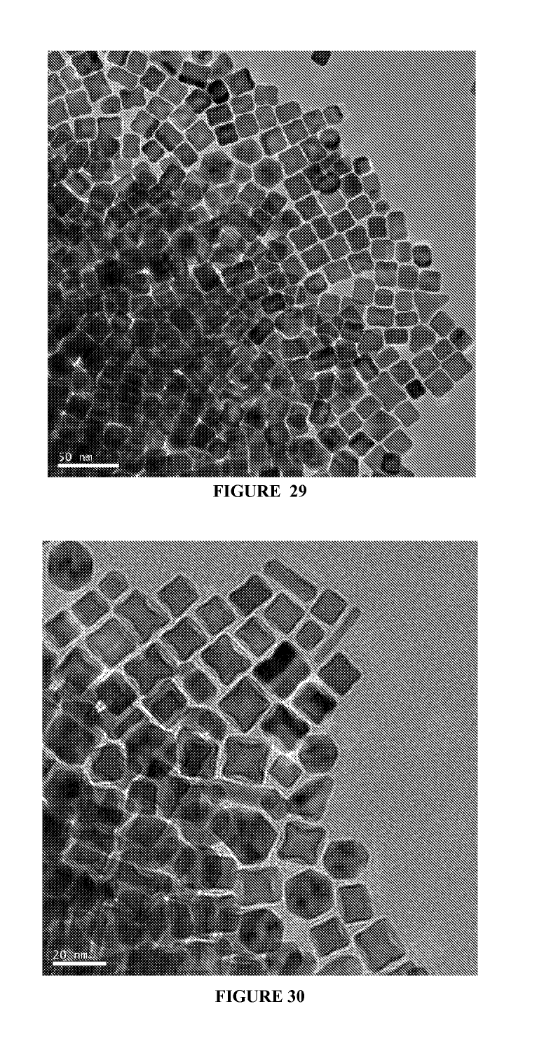

Transmission electron microscopy specimens are prepared as described above, except that 1 mg of reaction product was dispersed in 1 mL of chloroform. FIG. 29 shows TEM images of concave cubic PtNi nanoparticles obtained at 210° C. for 2 hr. The length of concave cube edge is around 20 nm. The cubic seeds selectively overgrow form corners and edges (the <111> and <110> directions of fcc structures) to form a concave structure.

### Example 29

### Synthesis of PtFe Concave Cubes

In a standard procedure, Pt(acac)₂ (13.3 mg), Fe(acac)₃ (11.8 mg), oleylamine (OAM) (9 mL) and oleic acid (OA) (1 mL) were mixed in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 210° C. under CO gas at the flow rate of 190 cm³/min. The reaction time is 60 min. The nanoparticles were separated by dispersing the reaction mixture with 3 mL of chloroform and 10 mL of ethanol, followed by centrifugation at 5000 rpm for 5 min. This procedure was repeated three times to wash away the excess reactants and capping agents. The final particles were dissolved in chloroform for further characterization.

Transmission electron microscopy specimens are prepared as described above, except that 1 mg of reaction product was dispersed in 1 mL of chloroform. FIG. 30 shows TEM images of concave cubic PtFe nanoparticles obtained at 210° C. for 1 hr. The length of concave cube edge is around 20 nm. The cubic seeds selectively overgrow form corners and edges (the <111> and <110> directions of fcc structures) to form a concave structure.

### Example 30

Preparation and electrochemical measurement of carbon-supported Pt alloy catalysts

Preparation of Carbon-Supported Pt Alloy Catalysts: Carbon black (Vulcan XC-72) was used as support for making shape-defined Pt alloy catalysts (Pt₃Ni/C). In a standard preparation, carbon black particles were dispersed in hexane and sonicated for 1 hour. A designated amount of Pt—Ni nanoparticles were then added to this dispersion at the nanoparticle-to-carbon-black mass ratio of 20:80. This mixture was sonicated for an additional 30 minutes and stirred overnight. The resultant solids were precipitated out by centrifugation and dried under stream of argon gas.

The solid product was then re-dispersed in n-butylamine at a concentration of 0.5 mg-catalyst/mL. This mixture was stirred for 3 days and then centrifuged at a rate of 5000 rpm for 5 minutes. The precipitate was re-dispersed in 10 mL methanol by sonication for 15 minutes and then separated by centrifugation. This procedure was repeated three times. The final samples were dispersed in ethanol for further usage.

A three-electrode cell was used to measure the electrochemical properties. The working electrode was a glassy-carbon rotating disk electrode (RDE) (area: 0.196 cm²). A 1 cm² platinum foil was used as the counter electrode and a HydroFlex hydrogen electrode was used as the reference, which was placed in a separate compartment. Hydrogen evolution reaction (HER) was used to calibrate this hydrogen electrode before the tests. All potentials in this paper are referenced to the Reversible Hydrogen Electrode (RHE). The electrolyte used for all the measurements was 0.1 M HClO₄, diluted from 70% double-distilled perchloric acid (GFS Chemicals, USA) with Millipore® ultra pure water. The mass of each Pt₃Ni/C catalyst was determined by thermogravimetric analysis (TGA) using an SDT-Q600 TGA/DSC system from TA Instruments at a ramp rate of 10° C./min to 600° C. in air followed by annealing at 600° C. for 30 minutes under a forming gas of 5% hydrogen in argon at a flow rate of 50 ml/min. To prepare the working electrode, 10 mg of the Pt₃Ni/C catalyst (20% based on the weight of alloy nanocrystals) was dispersed in 20 mL of a mixed solvent and sonicated for 5 minutes. The solvent contained a mixture of de-ionized water, isopropanol, and 5% Nafion in the volume ratio of 4:1:0.025. 20 μL of the suspension was added onto the RDE by a pipette and dried in air. The loading amount of the Pt₃Ni alloy nanocatalysts on the RDE was determined to be 9.3 μg_{Pt}/cm². The electrochemical active surface area (ECSA) measurements were determined by integrating the hydrogen adsorption charge on the cyclic voltammetry (CV) at room temperature in nitrogen saturated 0.1 M HClO₄ solution. The potential scan rate was 20 mV/s for the CV measurement. Measurements of oxygen reduction reaction (ORR) properties were conducted in a 0.1 M HClO₄ solution which was purged with oxygen for 30 minutes prior to, and during, the tests. The scan rate for ORR measurement was set at 10 mV/s in the positive direction. Data were used without iR-drop correction. For comparison, Pt/C (E-TEK, 20 wt % Pt on Vulcan carbon) was used as the baseline catalyst, and the same procedure as described above was used to conduct the electrochemical measurement, except that the Pt loading was controlled at 11 μg_{Pt}/cm².

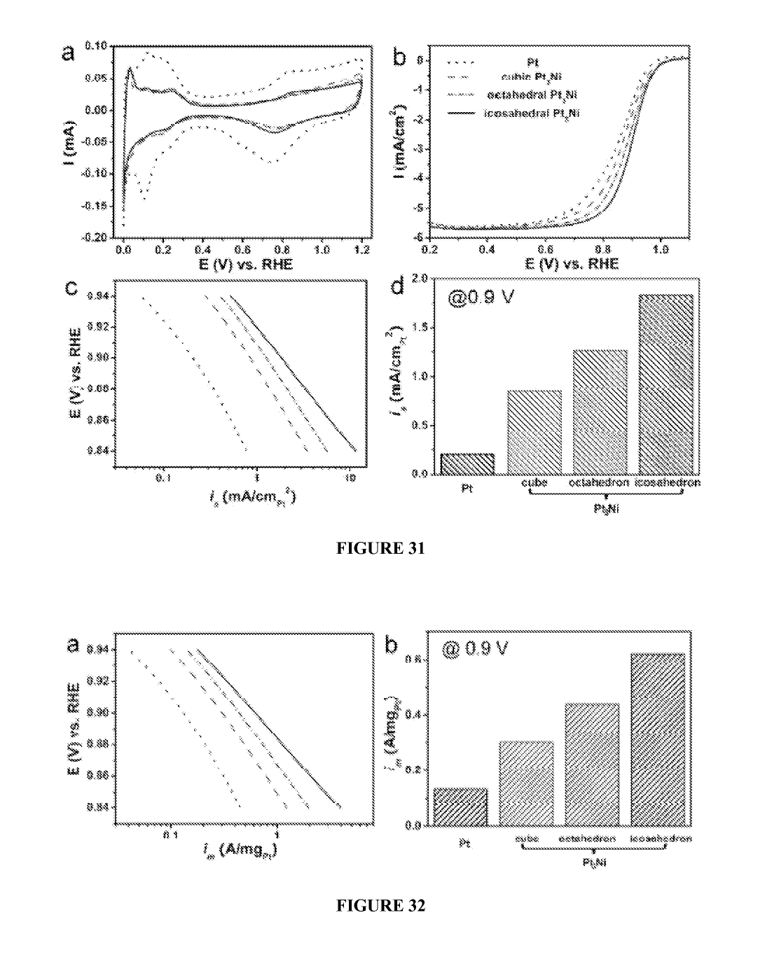

FIG. 31 shows the rotating disk electrode (RDE) polarization curves, which show that cubic, octahedral and icosahedral Pt₃Ni catalysts had more positive onset potentials and were more active than Pt. The area-specific ORR activities at 0.9 V were found to be 0.85 mA/cm²_{Pt} for the cubic Pt₃Ni catalyst, 1.26 mA/cm²_{Pt} for the octahedral Pt₃Ni catalyst, and 1.83 mA/cm²_{Pt} for the icosahedral Pt₃Ni catalyst (FIG. 31b to 32d). The ORR activity increased with a change from the cubic (100) shape to the (111) (octahedral or icosahedral) Pt₃Ni surfaces. Noticeably, the specific activity of icosahedral Pt₃Ni was an 800% improvement over that of the Pt/C (0.20 mA/cm²_{Pt}). The mass activity of this icosahedral Pt₃Ni catalyst is 0.62 Angstrom/mg_{Pt} (FIG. 32). These ORR activities of icosahedral Pt₃Ni catalyst are much better than the other {111} facet-bound Pt₃Ni/C catalysts. Octahedral or icosahedral Pt₃Ni particles outperformed the cubic nanocatalysts, because the former two shapes are bound by the {111} facets which are much more active than the {100} facets in the ORR. Interestingly, the activity of icosahedral Pt₃Ni catalysts was about 50% higher than that of the octahedral (1.26 mA/cm²_{Pt}), even though both shapes are bound by the {111} facets. This observation suggests the defect-induced morphology may have advantages over the platonic solids because of their difference in surface structures, such as curvatures, corners and edges.

### Example 31

This example describes preparation of carbon-supported truncated octahedral Pt₃Ni nanoparticle catalysts for oxygen reduction reaction (ORR). Besides the composition, size and shape controls, this example develops a new butylamine-based surface treatment approach for removing the long alkane-chain capping agents used in the solution phase synthesis. These Pt₃Ni catalysts can have the mass activity as high as 810 μA/cm²_{Pt} at 0.9 V, which is about four times better than the commercial Pt/C catalyst (˜0.2 mA/cm²_{Pt} at 0.9 V), an important threshold value to allow fuel cell powertrains to become cost-competitive with their internal combustion counterparts. Our results also show that the mass activities of these carbon-supported Pt₃Ni nanoparticle catalysts strongly depend on the (111) surface fraction, which validates the results from the study based on the Pt₃Ni extended single crystal surfaces, suggesting further development of catalysts with mass activity higher than the threshold values is highly plausible.

In this example, a facile approach to the preparation of truncated octahedral Pt₃Ni (t,o-Pt₃Ni) catalysts that have dominant exposure of {III} facets is presented. While thermally-annealed alloy catalysts typically take on cuboctahedral or truncatedoctahedral shapes, greater uniformity of shape and higher levels of crystalline and compositional control within each facet can be expected for shape-controlled nanocrystals. Butylamine is used in the room-temperature surface treatment to create carbon supported and shape-defined active electrocatalysts.

### Experimental Details

Synthesis of Pt₃Ni Nanoparticles. A mixture of borane-tert-butylamine complex (TBAB, Aldrich, 97%, 1.14 mmol), adamantanecarboxylic acid or adamantaneacetic acid (ACA or AAA, Aldrich, 99%, 1.2 mmol), hexadecanediol (Aldrich, 96%, 6.2 mmol), one of the following long alkane chain amines-hexadecylamine (HDA, TCI, 90% 8.28 mmol), dodecylamine (DDA, Aldrich, 98%, 8.28 mmol), and octadecylamine (ODA, Aldrich, 97%, 8.28% mmol)- and diphenyl ether (DPE, Aldrich, 90%, 2 ml) was added into a 25-mL three-neck round-bottle flask under argon protection. The reaction mixture was maintained at 190° C. using an oil bath. Platinum acetylacetonate (Pt(acac)₂, Strem, 98%, 0.127 mmol) and nickel acetylacetonate (Ni(acac)₂, Aldrich, 95%, 0.0424 mmol) were dissolved in 2-mL DPE at 60° C. followed by rapid injection into flask. The reaction was maintained at 190° C. for 1 hour. After the reaction, 200 μL of the product was mixed with 800 μL of chloroform in a plastic vial (1 mL), followed by the addition of 1 mL of ethanol. The precipitate was separated from the mixture by centrifugation at 5000 rpm for 5 minute. The supernatant was decanted and the black product was dispersed in 1 mL of chloroform. This process was repeated three times.

Preparation of Carbon-Supported Catalysts. Carbon black (Vulcan XC-72) was used as support for making platinum nickel catalysts (Pt3Ni/C). In a standard preparation, carbon black particles were dispersed in hexane and sonicated for 1 hour. A designed amount of platinum nickel nanoparticles were added to this dispersion at the nanoparticle-to-carbon-black mass ratio of 20:80. This mixture was further sonicated for 30 minutes and stirred overnight. The resultant solids were precipitated out by centrifugation and dried under an argon stream. The solid product was then re-dispersed in n-butylamine at a concentration of 0.5 mg-catalyst/mL. The mixture was kept under stirring for 3 days and then collected using a centrifuge at a rate of 5000 rpm for 5 minutes. The precipitate was re-dispersed in 10 mL methanol by sonicating for 15 minutes and then separated by centrifugation. This procedure was repeated three times. The final samples were dispersed in ethanol for further characterization.

Characterization. Transmission electron microscopy (TEM) and high-resolution transmission electron microscopy (HR-TEM) images were taken on a FEI TECNAI F-20 field emission microscope at an accelerating voltage of 200 kV. Scanning transmission electron microscopy (STEM) and elemental maps were carried out using the high-angle annular dark field (HAADF) mode on the same microscope. The optimal resolution of this microscopy is 1 Angstrom under TEM mode and 1.4 A under STEM mode. Energy dispersive X-ray (EDX) analysis of particle was also carried out on a field emission scanning electron microscope (FE-SEM, Zeiss-Leo DSM982) equipped with an EDAX detector. Powder X-ray diffraction (PXRD) patterns were recorded using a Philips MPD diffractometer with a Cu Ka X-ray source (λ=1.5405 A).

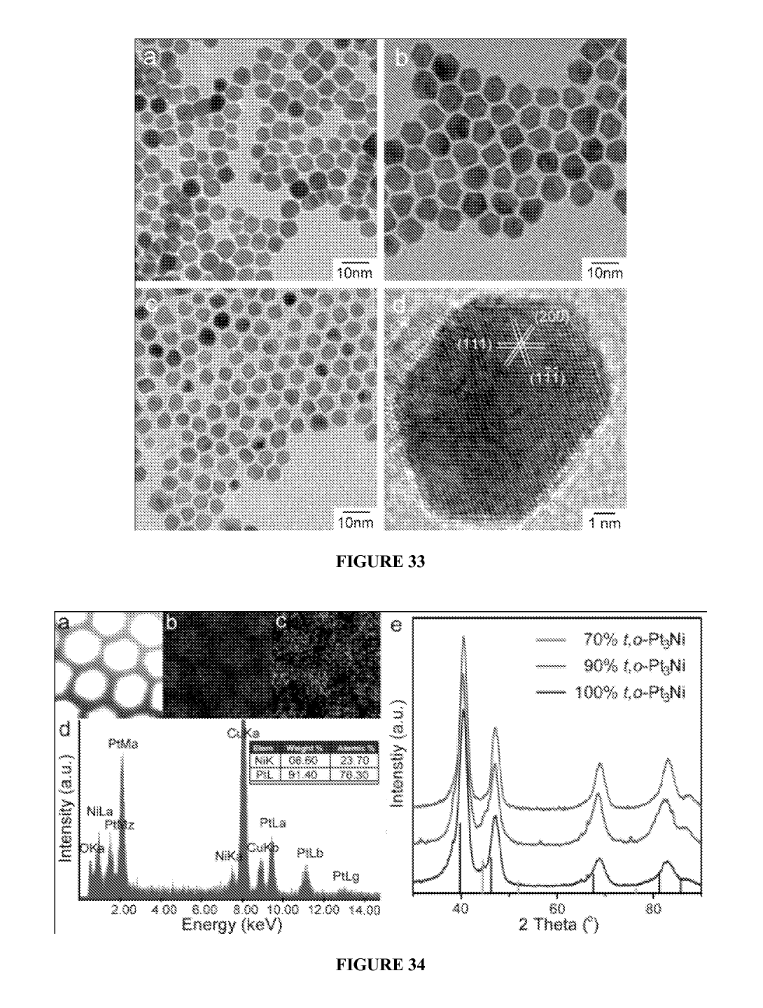

The shape-defined Pt—Ni nanoparticles were made from platinum acetylacetonate (Pt(acac)₂) and nickel acetylacetonate (Ni(acac)₂) in diphenyl ether (DPE) using a mixture of borane tert-butylamine complex (TBAB) and hexadecanediol as the reducing agents. Alkane-chain amines were used as the main capping. The transmission electron microscopy (TEM) images show the samples having both cubic and truncated octahedra shapes that were made under three different conditions. The population of truncated octahedra depended on the types and amounts of reducing and capping agents used. Among the various capping agents, short alkane-chain amines appeared to favor the formation of {111} facets. The highest population of cubes was observed when octadecylamine was used, while a small portion of cubes could still be observed when hexadecylamine was chosen. (FIGS. 33a and 33b). Only octahedra and truncated octahedral formed when dodecylamine was used (FIG. 33c). The d-spacing of the lattice was 0.219 nm for the truncated octahedron, matching closely with that of (111) plane of Pt3Ni alloy (0.221 nm) (FIG. 1 d). The cube had a d-spacing of 0.190 nm, which could be assigned to the (200) plane of Pt₃Ni alloy (0.191 nm). Both cubes and truncated octahedra had a distance of about 5 nm between the opposite faces for those particles shown in FIG. 33a or 33c, and about 7 nm for those particles shown in FIG. 33b. In addition to the choice of alkane-chain length, the reduction rate is critical for controlling both the composition and shape of Pt—Ni alloy nanoparticles. A combination of strong (TBAB) and mild (hexadecanediol) reducing agents was necessary to achieve the proper nucleation and growth rate. When only TBAB was used, irregularly faceted particles formed.

FIG. 34 shows high-angle annular dark-field scanning transmission electron microscopy (HAADF-STEM) image, its corresponding Pt and Ni elemental maps, and representative energy dispersive X-ray (EDX) analysis (recorded on a Zeiss-Leo DSM982 field-emission scanning electron microscope) of those 100% t, O—Pt/Ni nanoparticles. Both Pt and Ni distributed evenly in each nanoparticle (FIG. 34a-c). The Pt/Ni atomic ratio was 76/24, which is close to the composition of Pt₃Ni (FIG. 34d). Similar Pt/Ni atomic ratios were observed for the other two samples that had mixed cube and truncated tetrahedron shapes, indicating that this synthetic method was very effective in controlling the metal composition.

Powder X-ray diffraction (PXRD) patterns show that these truncated octahedra had a face-centered-cubic (fcc) structure with the peak positions in between those of Pt and Ni metals (FIG. 34e). The lattice constant was calculated to be 3.84 A for those cube-free nanoparticles based on PXRD data. This value corresponds to a composition around Pt₃Ni calculated according to Vegard's law and assuming a_{Pt}=3.923 Angstroms (Å) and a_{Ni}=3.524 Angstroms. The crystalline domain size was measured to be around 6 nm, using the full-width-at-half-maximum (FWHM) of the (III) diffraction based on the Dcbye-Scherrer formulation. This value is close to the dimension shown in the TEM images (FIG. 33 c). The other two types of nanoparticles had similar PXRD patterns, though the sample with 90% t,o-Pt₃Ni shape had sharper peaks than the others because of larger particle size.

These shape-controlled Pt₃Ni nanoparticles were loaded onto a carbon support (Vulcan XC-72) and subsequently treated with butylamine. This mild room temperature treatment was an important step in the production of active catalysts, as butylamine did not cause any changes in the morphology of the nanoparticles.

### Example 32

### Synthesis of Hyper-Branched Platinum Multipods

Pt(acac)₂ (100 mg or 0.25 mmol), ACA (180 mg, 1.0 mmol), 1,2-dodecane diol (DDD) (1.82 g or 9 mmol), and HDA (2 g or 8.2 mmol) were mixed with DPE (1 mL or 6.3 mmol) in a 25 mL three-neck round bottom flask equipped with a magnetic stirrer. The synthesis was carried out under argon atmosphere using the standard Schlenk line technique. The reaction flask was immersed in a glycerol bath set at 130° C., and the reaction mixture turned into a transparent yellowish solution at this temperature. The flask was then transferred to a second glycerol bath set at a designed temperature at 160° C. The reaction time varied from 30 minutes to 160 minutes. The nanoparticles were separated by dispersing the reaction mixture with 8 mL of chloroform and 10 mL of ethanol, followed by centrifugation at 5000 rpm for 5 minutes. This procedure was repeated three times to wash away the excess reactants and capping agents. The product was redispersed in n-butylamine at a concentration of 0.5 mg/mL (nanocrystals by weight/butylamine by volume). The mixture was under stirring for 3 days and then centrifuged at 5000 rpm for 5 minutes. The precipitate was redispersed in 10 mL methanol by sonicating for 15 minutes and separated by centrifugation. This washing procedure was repeated three times. The final particles were dissolved in ethanol for further characterization.

Transmission electron microscopy specimens are prepared by dispersing 1 mg of reaction product in 1 mL of chloroform. The dispersed reaction product is drop-cast onto a carbon-coated copper grid. AVG HB501 ultra-high vacuum scanning transmission electron microscope (UHV-STEM) by Cornell and a 2000 EX transmission electron microscope by JEOL are used to examine the size and shape of the obtained nanoparticles. The UHV-STEM is also used to conduct nano-electron diffraction (ED) of individual nanoparticles. The electronic gun of the UHV-STEM is focused into a spot with a diameter of less than 1 μm. Powder x-ray diffraction (PXRO) spectra are recorded with a Philips MPD diffractometer using a Cu Ka X-ray source (A=1.5405 A) at a scan rate of 0.013 2 theta/s.

FIGS. 35a-d show the TEM images of the Pt nanoparticles obtained at 160° C. for reaction time ranging from 30 to 160 minutes. At the initial 30 minutes, FIG. 35a, the nanocrystals grow into 3-D multipods and a few particles with longer branches can be observable. Some morphology of multipod crystals resemble those that are previously reported, but the difference is that in the current embryonic crystals, the branches begin to develop, as the reaction continued, as shown in FIGS. 35b and 35c, the anisotropic growth of Pt multipod crystals become obvious and the length of branches grow to around 60 run with the diameter of about 4.3 run (FIG. 35c). The anisotropic growth of Pt crystals also leads to the change of solution color from initial yellow to brown and ultimately to black. When the reaction time reaches 160 minutes, the branches further grow to more than 80 nm, but the diameter still keep about 4.3 nm. At the same time, the hyper-branched Pt multipods can self-assemble to form porous networks on the carbon film coated copper grid.

FIGS. 35g and 35h show the high resolution TEM images of the branches. In FIG. 35g, a lattice spacing of 2.4 Angstroms can be observed in the high-resolution TEM image of the nanorods, corresponding to the ⅓ [422] plane of fcc platinum. It indicates that the branch grows along the (211) direction, which is also observed in the growth of tripod Pt nanostructures. Another kind of growth mode of Pt branches is observed and shown in FIG. 35h. The lattice distance normal to the growth direction of the branch is 1.97 Angstroms, matching the lattice space of (100) plane of Pt. The (111) plane with a d-spacing of 2.27 A can also been assigned. The measured angle between (100) and (111) plane is 55° which is equal to the calculated value.

In order to clean the surface of hyper-branched Pt multipods, a modified ligand exchange method is introduced to get rid of the capping agent, as schematically shown in FIG. 36. At the first step, after the precipitated nanoparticles are redispersed and stirred in n-butylamine for 3 days, the amine with a long alky chain, HDA, is replaced by n-butylamine. And then the n-butylamine can be removed by sonication-assisted washing with methanol. The ligand exchange process is mainly due to the competitive adsorption of amine with long and short alky chains on the surface of Pt nanoparticles, which is controlled by the concentration. Obviously, the excessive amount of n-butylamine will improve their dominatively occupying the particle surface during the stirring. The n-butylamine molecular can be removed by washing with methanol which should be attributed to the polarity of n-butylamine higher than that of HDA, which leads to n-butylamine being more soluble than HDA in methanol. FIGS. 36b and 36c show the images of Pt multipods before and after ligand exchange process indicating that the particle still keeps hyper-branched morphology after the ligand exchange and washing process. Thermogravimetric analysis (TGA) measurements are used to determine the efficiency of ligand exchange and washing. As shown in FIG. 36d (before ligand exchange), the major weight loss of about 3% occurred at ˜140° C. should be due to desorption of HDA, as confirmed by the measurement of pure HDA. After ligand exchange, the weak mass loss of 0.7% within initial 200° C. could be attributed to desorption of remnants HDA, n-butylamine and methanol. The mass loss ranging from ˜400 to 550° C. for both of them is found to be a feature common to both gold and platinum nanoparticles capped by HDA, which is ascribed to the desorption of the nanoparticles at this relatively low temperature. The TGA measurement shows that most of capping agent has been removed through ligand exchange method.

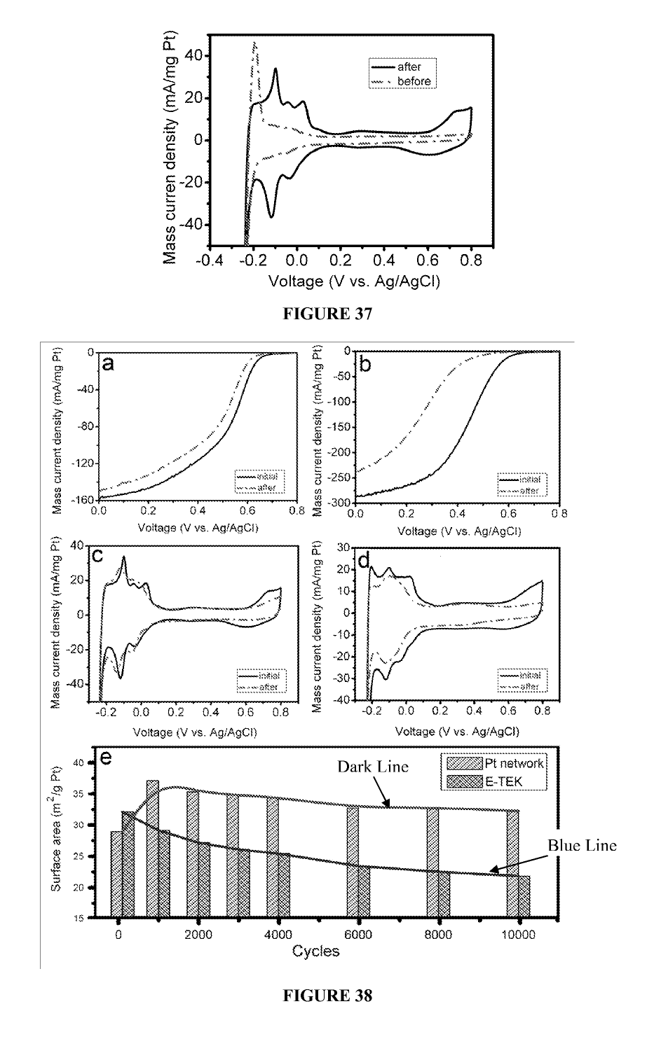

Cyclic voltammograms (CV) of supportless hyper-branched Pt multipods catalysts are used to study the active platinum surface through hydrogen adsorption-desorption in an argon purged 0.5 M H₂SO₄ at room temperature upon multiple cycles between 0 and 1 V. Obviously, once the active sites on the surface of catalysts are preferentially occupied by capping agents, active surface of catalysts will suffer a great loss. As shown in FIG. 37, CV of hyper-branched Pt multipods is performed to further investigate the ligand exchange efficiency. It indicates that after ligand exchange, the hydrogen adsorption-desorption peaks between 0.05 and 0.4 V are observable. Comparatively, the Pt multipods without ligand exchanging only show a sharp peak between 0 to 0.05 V, which should be attributed to the effects of capping agent, when the catalysts after 10,000 CV cycles was re-contaminated by HDA, the similar peaks were found. The CV characterization shows that the active sites on the surface of platinum occupied by capping agent were released after the ligand exchange.

The stabilization of supportless hyper-branched Pt multipods and E-TEK was determined in an accelerated stability test by continuously applying potential sweeps from 0.36 to 0.76 V (Vs. Ag/AgC1; 0.6 to 1 V Vs. RHE) at a rate of 50 mV/s in an Ar-purged 0.5 M H₂SO₄ solution at room temperature, which causes oxidation/reduction cycles of Pt atoms on the surface of catalysts. The catalysts of Pt multipods and E-TEK were loaded on a rotating disk electrode with the same Pt loading amount, during the sweeping, the changes in the Pt surface area and electrocatalytic activity of the ORR are determined after certain cycles. Before the ORR measurements, the H₂SO₄ solution is saturated by O₂ for 20 minutes in advance. The catalytic activity of supportless Pt multipods measures as the currents of O₂ reduction obtained before and after 10,000 potential cycling, shows a 43 mV degradation in half-wave potential over the cycling period (FIG. 38), while the corresponding change for E-TEK has a loss of 185 mV (FIG. 38b).

CV is used to study the active platinum surface in an argon purged 0.5 M H₂SO₄ at room temperature upon sweeping between −0.24 to 0.8 V (Vs. Ag/AgCl; 0 to 1 V Vs. RHE) by measuring H adsorption before and after 10000 potential cycling. The areas integrated for the curves between −0.19 and 0.16 V (Vs. Ag/AgCl; 0.05 to 0.4 V Vs. RHE) are associated with hydrogen adsorption-desorption on platinum surfaces and can be used to calculate the electrochemical surface area (ECSA), as shown in FIGS. 38c and 38d. It is found that the E-TEK is reduced considerably from 37.6 m²/g_{Pt} to 25.5 m²/g_{Pt} after 10,000 cycles, 32.2% of the initial area is lost, and it shows a continuous decrease of ECSA during the potential cycling, shown in FIG. 38e (blue line). In contrast, the supportless Pt mutipods shows a rapid increase from 30.3 m²/g_{Pt} to 39.4 m²/g_{Pt} after initial 1000 cycles which is followed by a slow decrease to 34 m²/g_{Pt} after 10,000 cycles, shown in FIG. 38e (dark line). This phenomenon can be attributed to that the remnant capping agents are completely removed at initial stage, therefore, the ECSA of Pt multipods reach to a maximum after around 1000 CV cycles which is followed by a slow reduction from the maximum 39.4 m²/g_{Pt} to 34 m²/g_{Pt} the loss is 13.7% of the maximum values.

The activity loss of Pt catalysts can be ascribed to the Ostwald ripening improved growth of Pt nanocrystals, the aggregation of Pt nanoparticles through Pt nanocrystals migrating on the carbon support and carbon corrosion induced Pt nanocrystals dissociation from the support. In order to investigate the degradation of the catalysts, the Pt multipods and Pt/C are examined by TEM after the CV cycling. The Pt nanoparticles of in E-TEK are found to form large aggregates after CV cycling, confirming that the loss of ECSA might be due to the ripening and carbon corrosion induced aggregation. By contrast, there are no noticeable changes for the morphology of the Pt multipods and they still keep hyperbranched structures. The loss of activity of Pt multipods might be attributed to the mild dissolution of platinum.

While the invention has been particularly shown and described with reference to specific embodiments (some of which are preferred embodiments), it should be understood by those having skill in the art that various changes in form and detail may be made therein without departing from the spirit and scope of the present invention as disclosed herein.

1) A method of making metal or metal-alloy nanoparticles comprising the steps of:
a) providing at least one reducible metal precursor and, optionally, a solvent and/or a surfactant, wherein the solvent is selected from organic solvent, aqueous solvent, ionic liquid and combinations thereof;
b) maintaining the material from a) at least at a reducing temperature at which the at least one reducible metal precursor is reduced; and
c) contacting the material from b) with a reducing gas at the reducing temperature, thereby forming nanoparticles;
wherein the nanoparticles have a shape selected from octahedral, tetrahedral, dodecahedron, icosahedral, truncated octahedral, truncated tetrahedral, cubic, spherical, bipyramid, multipod, nanowire, and porous nanowire.

2) (canceled)

3) The method of claim 1, further comprising the step of collecting the nanoparticles.

4) The method of claim 1, further comprising the step of contacting the nanoparticles with small molecules, wherein the small molecules comprising one or more functional groups comprising a nitrogen atom, an oxygen atom, a sulfur atom, a phosphorus atom and combinations thereof,
such that the small molecules are attached to at least a portion of the surface of the nanoparticle.

5) The method of claim 4, wherein the small molecules comprise at least one alkyl moiety and all the alkyl moieties have from 1 carbon to 6 carbons.

6) The method of claim 4, wherein the functional group is selected from the group consisting of alcohols, amines, carboxylic acids, phosphonic acid esters, phosphate esters and combinations thereof.

7) The method of claim 4, wherein the nanoparticles are loaded onto a support material before contacting the nanoparticles with the small molecules.

8) The method of claim 4, wherein the small molecule is a primary amine selected from n-butylamine, sec-butylamine, tert-butylamine, isobutylamine, propylamine, ethylamine, methylamine and combinations thereof.

9) The method of claim 1, wherein the reducible metal precursor comprises a metal selected from the group consisting of platinum, palladium, gold, silver, ruthenium, rhodium, osmium, iridium, titanium, vanadium, chromium, manganese, molybdenum, zirconium, niobium, tantalum, zinc, cadmium, bismuth, gallium, germanium, indium, tin, antimony, lead, tungsten, samarium, gadolinium, copper, cobalt, nickel, iron and combinations thereof.

10) The method of claim 1, wherein the reducible metal precursor is selected from the group consisting of metal-based salts and hydrated forms thereof, metal-based acids and hydrated forms thereof, metal-based bases and hydrated forms thereof, and organometallic compounds.

11) The method of claim 10, wherein the organometallic compound is a metal-acetylacetonate compound selected from the group consisting of Pt(acac)₂, Pd(acac)₂, Ni(acac)₂, Co(acac)₂, Cu(acac)₂, Fe(acac)₃ Ag(acac), or a metal-fluoroacetylacetonate compound selected from Pt(CF₃COCHCOCF₃)₂ and Ag(CF₃COCHCOCF₃), or a metal-acetate compound selected from the group consisting of Pd(ac)₂, Ni(ac)₂, Co(ac)₂, Cu(ac)₂, Fe(ac)₃ and silver stearate, or a metal-cyclooctadiene compound selected from the group consisting of Pt(1,5-C₈H₁₂)Cl₂, Pt(1,5-C₈H₁₂)Br₂ and Pt(1,5-C₈H₁₂)I₂.

12) The method of claim 10, wherein the metal-based salt is selected from the group consisting of PtCl₂, PtCl₄, K₂PtCl₆, K₂PtCl₄, H₂PtCl₆, H₂PtBr₆, Pt(NH₃)Cl₂, PtO₂, Na₂PdCl₄, Pd(NO₃)₂, HAuCl₄, Ag(NO₃)₂, NiCl₂, CoCl₂, CuCl₂ and FeCl₃.

13) The method of claim 1, wherein the surfactant is selected from the group consisting of oleylamine, octadecylamine, hexadecylamine, dodecylamine, oleic acid, adamantaneacetic acid and adamantinecarboxylic acid, polyvinylpyrrolidone (PVP), citrate acid, sodium citrate, cetylpyridinium chloride (CPC), tetractylammonium bromide (TTAB), cetyl trimethylammonium bromide (CTAB), cetyl trimethylammonium chloride (CTACl) and combinations thereof.

14) The method of claim 1, wherein the reducing gas is selected from the group consisting of carbon monoxide (CO), hydrogen (H₂), forming gas comprising nitrogen gas and hydrogen (H₂), syngas comprising hydrogen (H₂) and carbon monoxide (CO), ammonia gas (NH₃), ozone (O₃), peroxide (H₂O₂), hydrogen sulfide (H₂S), ethylenediamine and combinations thereof.

15) The method of claim 1, wherein the reducing gas is produced in situ from a metal carbonyl compound.

16) The method of claim 1, wherein the solvent is an organic solvent selected from the group consisting of diphenyl ether, octyl ether, oleylamine, octadecylamine, hexadecylamine, dodecylamine and combinations thereof.

17) The method of claim 1, wherein the solvent is mixture of organic solvent and water and the organic solvent is selected from the group consisting of ethylene glycol (EG) ethanol, methanol, polyethylene glycol (PEG) and combinations thereof.

18) The method of claim 1, wherein the reducing temperature is from 5° C. to 380° C.

19) The method of claim 1, wherein the material is contacted with a reducing gas at a flow rate of 10 cm³/min to 210 cm³/min.

20) (canceled)

21) (canceled)

22) (canceled)

23) A method of making core-shell metal or metal-alloy nanoparticles comprising the steps of:
a) providing at least one reducible metal or metal-alloy precursor and, optionally, a solvent and/or a surfactant, wherein the solvent is selected from organic solvent, aqueous solvent, ionic liquid and combinations thereof;
b) maintaining the material from a) at least at a first reducing temperature at which the at least one reducible metal core precursor is reduced; and
c) contacting the material from b) with a reducing gas, thereby forming metal or metal-alloy nanoparticles, wherein the nanoparticles form the core of the core-shell nanoparticles and have a shape selected from octahedral, tetrahedral, dodecahedron, icosahedral, truncated octahedral, truncated tetrahedral, cubic, spherical, bipyramid, multipod, nanowire, and porous nanowire;
d) combining the nanoparticles from step c) with at least one reducible metal precursor and, optionally, a solvent and/or a surfactant, wherein the solvent is selected from organic solvent, ionic liquid, aqueous solvent and combinations thereof;
e) maintaining the material from d) at least at a second reducing temperature at which the at least one reducible metal precursor is reduced; and
f) contacting the material from e) with a reducing gas, thereby forming the shell of the core-shell nanoparticles, wherein the shell is a metal or metal alloy;
wherein the core-shell nanoparticles have a shape selected from octahedral, tetrahedral, dodecahedron, icosahedral, truncated octahedral, truncated tetrahedral, cubic, spherical, bipyramid, multipod, nanowire, and porous nanowire.

24) (canceled)

25) (canceled)

26) Nanoparticles comprising a metal selected from gold, silver, palladium, platinum, or a metal alloy, wherein the nanoparticles have an icosahedron shape comprised of multiple tetrahedral nanocrystals with multiple twin planes, resulting in a structure bound by multiple {111}facets, wherein the nanoparticles comprise a platinum alloy having the formula PtₓMₐQ_{b}T_{c}, wherein x+a+b+c=100 and x is from 1 to 99, and wherein M or Q or T is a metal selected from the group consisting of palladium, rhodium, gold, silver, nickel, cobalt, copper, tungsten, iridium, titanium, vanadium, zirconium, niobium, molybdenum, manganese, indium, tin, antimony, lead, bismuth, and iron.

27) (canceled)

28) (canceled)

29) (canceled)

30) (canceled)

31) (canceled)

32) (canceled)

33) (canceled)

34) (canceled)

35) (canceled)

36) (canceled)
